(19) United States
(12) Patent Application Publication
(10) Pub. No.: US 2023/0419085 A1
(43) Pub. Date: Dec. 28, 2023

(54) METHODS AND SYSTEMS FOR AUTOMATIC DIFFERENTIATION OF DISCRETE AND DISCRETE-CONTINUOUS STOCHASTIC PROGRAMS

(71) Applicants: JuliaHub, Inc., Boston, MA (US); University of Basel, Basel (CH)

(72) Inventors: Christopher Rackauckas, Cambridge, MA (US); Moritz Schauer, Gothenburg (SE); Frank Schäfer, Cambridge, MA (US); Gaurav Arya, Cambridge, MA (US)

(21) Appl. No.: 18/340,594

(22) Filed: Jun. 23, 2023

Related U.S. Application Data
(60) Provisional application No. 63/354,725, filed on Jun. 23, 2022.

(51) Int. Cl. G06N 3/047

(52) U.S. Cl. CPC G06N 3/047

(57) ABSTRACT

Systems and methods for computation of derivatives of stochastic programs are disclosed. A system having at least one processor is configured for automatically determining a derivative of an expectation of a stochastic program with respect to its input parameters, where the stochastic program includes continuous and discrete sources of randomness.

### CROSS-REFERENCE TO RELATED APPLICATIONS

This application claims priority to and the benefit of U.S. Provisional Patent Application No. 63/354,725, entitled “METHODS AND SYSTEMS FOR AUTOMATIC DIFFERENTIATION OF DISCRETE AND DISCRETE-CONTINUOUS STOCHASTIC PROGRAMS,” which was filed on Jun. 23, 2022, the entire contents of which is hereby incorporated by reference.

### TECHNICAL FIELD

The field of the invention relates generally to methods and systems for continuous and discrete stochastic programming. More specifically, the invention relates to automatic differentiation of discrete and discrete-continuous stochastic programs.

### BACKGROUND

Stochastic programming is a framework for modeling optimization problems that involve uncertainty. A stochastic program is an optimization problem in which some or all problem parameters are uncertain but follow known probability distributions. The goal of stochastic programming is to find a decision which both optimizes some criteria chosen and accounts for the uncertainty of the problem parameters. Because many real-world decisions involve uncertainty, stochastic programming has many applications.

In two-stage stochastic programming, decisions may be based on data available at the time the decisions are made rather than depending on future observations. A two-stage problem may assume that the second-stage data can be modeled as a random vector with a known probability distribution, which may be justified in some situations. To solve a two-stage stochastic problem numerically, one may need to assume that the random vector has a finite number of possible realizations with respective probability masses. The two-stage problem can then be formulated as one large linear programming problem called the deterministic equivalent of the original problem.

A stochastic linear program is a specific instance of a classical two-stage stochastic program. A stochastic linear program is built from a collection of multi-period linear programs, each having the same structure but somewhat different data. With a finite number of scenarios, two-stage stochastic linear programs can be modelled as large linear programming problems. This formulation is often called the deterministic equivalent linear program.

One approach to reduce the scenario set to a manageable size is by using Monte Carlo simulation, which is a class of computational algorithms that rely on repeated random sampling to obtain numerical results. Monte Carlo simulation uses randomness to solve problems that might be deterministic in principle.

One drawback to current stochastic programming methods and systems is that computation of the derivative of the expectation of a stochastic program X(p), with respect to its input p, in the case where X(p) may contain sources of both discrete and continuous randomness (e.g., as part of a sensitivity analysis or optimization procedure) is not automatic. In other words, no current method or system exists for automatic computation of these estimates, whereby a single forward pass through a program returns an estimate of the derivative.

Accordingly, a need exists for improved methods and systems for continuous and discrete stochastic programming.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Systems and methods for automated computation of the derivative of the expectation of a stochastic program with respect to its parameters are disclosed.

According to one embodiment, a programmatic method for performing language-level automatic differentiation of a stochastic program is disclosed. The programmatic method includes receiving a user-provided stochastic program. The programmatic method further includes generating a stochastic derivative based on the user-provided stochastic program. The programmatic method further includes generating an estimator for the user-provided stochastic program using the stochastic derivative. The estimator may be unbiased and/or automated. The estimator determines an estimate of a derivative of the user-provided stochastic program. The estimate of the derivative determined by the estimator may be applied to a simulation or other model to accelerate hardware running the simulation or other model.

According to another embodiment, a system for automated computation of a derivative of the expectation of a stochastic program is disclosed. The system includes a memory and at least one processor. The at least one processor is configured for automated computation of the derivative of the expectation of a stochastic program with respect to its parameters including automatically determining a derivative of an expectation of a user-provided stochastic program with respect to its input parameters, where the user-provided stochastic program includes continuous and discrete sources of randomness.

According to another embodiment, a method for automated computation of a derivative of the expectation of a stochastic program is disclosed. The method includes automatically determining a derivative of an expectation of a user-provided stochastic program with respect to input parameters of the user-provided stochastic program, wherein the user-provided stochastic program includes continuous and discrete sources of randomness.

### BRIEF DESCRIPTION OF THE DRAWINGS

The present embodiments are illustrated by way of example and are not intended to be limited by the figures of the accompanying drawings.

FIG. 1 depicts a qualitative sketch of a method and comparison to finite differences according to one embodiment.

FIG. 2 depicts an illustration of the method according to an embodiment of the subject matter described herein.

FIG. 3A illustrates a comparison of the change X(p+h)−X(p) for outputs with continuous and discrete distribution.

FIG. 3B shows charts illustrating the effect of perturbing the probability of a Bernoulli variable X(p) with p=½ by an infinitesimal h>0 according to an embodiment of the systems and methods described herein.

FIG. 4 depicts example source code for implementing a stochastic dual structure according to an embodiment of the systems and methods described herein.

FIG. 5 depicts example source code for obtaining an unbiased estimate of ∂ₚ Geo(p)³ according to an embodiment of the systems and methods described herein.

FIG. 6 depicts example source code for implementing an idiom for making a discrete choice in a program according to an embodiment of the systems and methods described herein.

FIG. 7 example source code for implementing a structure for an infinitesimal event according to an embodiment of the systems and methods described herein.

FIG. 8 depicts an example of different backends for storing a set of finite differentials using a dictionary approach, a pruning approach, and a smoothing approach.

FIG. 9 depicts exemplary source code for an implementation of a stochastic triple structure (simplified) according to an embodiment of the systems and methods described herein.

FIG. 10 depicts exemplary source code for propagating a stochastic triple through Geo(p)³ according to an embodiment of the systems and methods described herein.

FIG. 11 depicts example source code for a differentiable random walk according to an embodiment of the systems and methods described herein.

FIG. 12 depicts an exemplary computing environment suitable for implementing the methods according to an embodiment of the systems and methods described herein.

FIG. 13 depicts example source code for a differentiable rejection sampler according to an embodiment of the systems and methods described herein.

FIG. 14 illustrates an exemplary particle sampler application of the systems and methods described herein.

FIG. 15 illustrates automatic differentiation of discrete-time Markov processes according to an embodiment of the systems and methods described herein.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

The combination of traditional computer programs with machine learning or their direct optimization via stochastic gradient descent empowered by automatic differentiation (AD) is applicable across many scientific disciplines. Often, it is desirable to optimize stochastic objectives including computing gradients of stochastic programs. When stochastic programs contain only continuous randomness, such as Gaussian distributions, the reparameterization trick enables low-variance gradient estimates. However, existing AD techniques either do not support discrete randomness or rely on methods that suffer from high variance, a need to tune or optimize method hyperparameters, or exponential blowup in running time as more discrete stochastic variables are composed together.

As mentioned above, automatic differentiation (AD) is a technique for constructing new programs which compute the derivative of an original program. However, AD systems have been restricted to the subset of programs that have a continuous dependence on parameters. Programs that have discrete stochastic behaviors governed by distribution parameters, such as flipping a coin with probability p of being heads, pose a challenge to these systems because the connection between the result (heads vs tails) and the parameters (p) is fundamentally discrete. The systems and methods described herein include a new reparameterization methodology that allows for generating programs whose expectation is the derivative of the expectation of the original program. This gives an unbiased and low variance estimator which is as automated as traditional AD mechanisms. The systems and methods described herein also demonstrate various applications including, for example, unbiased forward-mode AD of discrete-time Markov chains, agent-based models such as Conway's Game of Life, and unbiased reverse-mode AD of a particle filter.

The subject matter described herein includes systems and methods for language-level AD of discrete and discrete-continuous stochastic programs, with emphasis on general-purpose composability, low variance, and preservation of a program's discrete structure, opening up applications of AD to the broad field of stochastic programs containing discrete randomness, such as random processes with discrete state space and (sequential) Monte Carlo methods employing resampling techniques. This results in an order-of-magnitude variance reduction for unbiased forward-mode AD of discrete random programs and, as an illustration of the present subject matter's applicability, the unbiased, reverse-mode AD of a particle filter.

Automatic differentiation is a technique for taking a mathematical program X(p) and generating a new program

$$\tilde{X} ( p ) = \frac{d X}{dp}$$

for computing the derivative. AD increases performance of gradient-based optimization techniques compared to derivative-free methods. However, if X(p) returns the flip of a coin, with probability p of receiving a 1 and probability 1−p of receiving a 0, dX/dp is not defined in the classical sense. When attempting to calibrate the parameter p to data, one may wish to fit the model using the statistical quantities. For example, one may find p such that the average of X(p) is close to the average sum of N real-world coin flips. Given this use case, is it possible for a compiler or other computing device to automatically construct a program \tilde{X}(p) that computes the statistical quantities of the derivative? In other words,

$$E [ \tilde{X} ( p ) ] = \frac{d E [ X ( p ) ]}{dp} ?$$

One solution to this problem would be to use finite differences, i.e.:

$$\frac{d 𝔼 [ X ( p ) ]}{d p} \approx \frac{𝔼 [ X ( p + ε ) ] - 𝔼 [ X ( p ) ]}{ε}$$

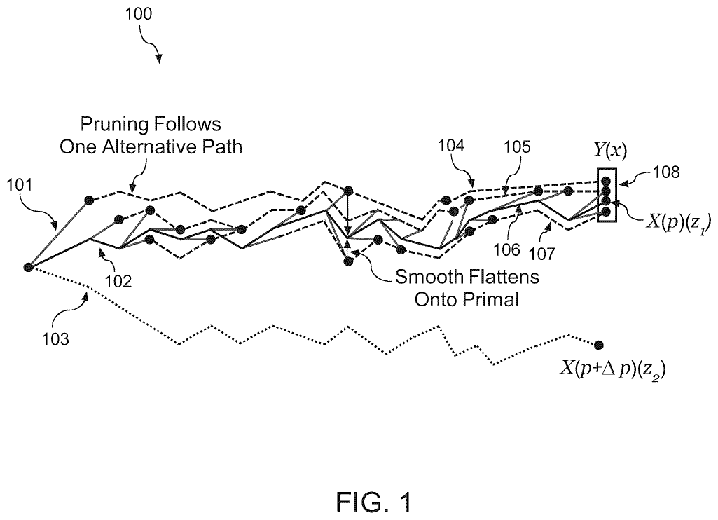

One issue with finite differences in the context of stochastic programs is that this calculation does not correlate the calculation of [symbol] [X(p+ε)] with the calculation [symbol] [X(p)]. This leads to a large variance in the finite difference estimator that is non-vanishing (the variance goes to ∞ as ε→0). This variance issue can be alleviated if the perturbed program was run with the same set of random numbers, i.e., directly compute [symbol] [X(p+ε)−X(p)], as depicted in FIG. 1.

FIG. 1 illustrates a qualitative sketch of a method and comparison to finite differences according to one embodiment. The primal computation samples X(p) with random number sequence z₁. Black-box finite differences samples an independent copy of the program X′(p+ε) with random number sequence z₂ (bottom, line 103) for some finite choice of ε. In contrast, the stochastic derivative Y is coupled to the primal computation, considering the effect of the minimal possible perturbations (dotted black lines 104, 105, and 107) to the program.

The systems and methods described herein demonstrate how to automatically construct a stochastic program \tilde{X}(p) whose expectation satisfies

$$E [ \tilde{X} ( p ) ] = \frac{d E [ X ( p ) ]}{dp} .$$

This is derived by performing a “stochastic derivative” technique, which includes propagating the proportional probability of differing event outcomes due to infinitesimal changes in p. The “stochastic derivative” technique used by the systems and methods described herein provides several real-world benefits in the context of scientific computing: composability, preservation of program structure, unbiased and low variance, and speed.

An object of the systems and methods described herein includes performing automated computation of the derivative of the expectation of a stochastic program with respect to its parameters.

The systems and methods described herein include general-purpose automatic differentiation of discrete and discrete-continuous stochastic programs. Their utility is demonstrated by showing real-world, practical applications such as AD of stochastic simulations like inhomogeneous random walks, AD of agent-based models such as the Game of Life, and building an end-to-end differentiable particle sampler. This allows for simulations that are otherwise impractical or impossible to simulate. Additionally, the systems and methods described herein provide an implementation of the method StochasticAD.j1, to apply the technique to other applications. Thus, the systems and methods described herein improve computing by making possible simulations that were previously impractical or impossible. This allows for the computing hardware running these simulations to perform faster and more efficiently.

Composability: Performing language-level AD of stochastic programs composed of any of a wide range of random “building blocks,” including draws from discrete distributions such as Bernoulli, Geometric, and Poisson distributions, with only a constant-factor increase in computational cost irrespective of the number of random building blocks or how they are composed together.

Primal Coupling: For continuous randomness, low-variance derivative estimates are made possible by the reparameterization trick. The reparameterization trick is generalized to the discrete case by fully coupling the primal and derivative computations (i.e., they share the same source of randomness), leading to variance reduction.

Preservation of Program Structure: A single run of the primal computation is transformed into an unbiased estimate of the derivative in a stateless fashion, with no internal parameters to tune, optimize or update from run-to-run. The discrete structure of the original program is faithfully preserved, avoiding continuous relaxations and user-tuned parameters and allowing meaningful differentiation of discrete functions of discrete random variables, such as array indexing.

One real-world, practical application of the systems and methods described herein includes epidemiological modeling. In epidemiological modeling, the basic reproduction number, denoted R₀, is often of interest. The basic reproduction number of an infection is inherently an expected value because it is the expected number of cases directly generated by one case in a population where all individuals are susceptible to infection. Also in epidemiological modeling, a stochastic simulator for an infection chain is an example of a stochastic program.

Another real-world, practical application of the systems and methods described herein includes, in Bayesian inference, an example where samples of the posterior distribution obtained from Monte Carlo simulation can be used to compute statistical estimates such as a posterior mean or a posterior variance. These also take the form of expected values.

The derivative of such expectations is important to answer questions about sensitivities (“Which are the most important system parameters and how do they affect the expected system outcome?”) and questions about optimal choice of parameters (“How should parameters change to achieve a desirable expected result?”).

The systems and methods described herein automatically augment an arbitrary stochastic program, besides the output, to also return a stochastic derivative, whose samples serve as an estimate of the derivative of the program's expectation with respect to the input. This means:

$$\frac{\partial 𝔼 [ X ( p ) ]}{\partial p} \approx \frac{1}{n} {\sum }_{i = 1}^{n} \partial {X}^{( i )}$$

where ∂X⁽¹⁾, ∂X⁽²⁾, . . . , ∂X⁽ⁿ⁾ denote samples of such a stochastic derivative, just as similar as samples of a stochastic gradient on average corresponds to the actual gradient.

In the case of purely continuous randomness (e.g., Gaussian noise), the systems and methods described herein estimate the derivative by considering all random noise as an explicit input of the program and differentiating the program for a fixed noise value (also referred to as “the reparameterization trick”).

The systems and methods described herein introduce primal-conditioned derivatives for stochastic programs, which are defined as expectations of derivatives conditional on the primal evaluation. Primal-conditioned derivatives can be understood as taking derivatives averaged over all possible evaluations of the primal program that give rise to observable behavior.

This creates a practical object that generalizes the reparameterization trick to the discrete case and to arbitrary mixtures of discrete and continuous randomness. Primal-conditioned derivatives enable a new paradigm for the differentiation of stochastic programs, where all discrete structure in the original stochastic program is faithfully preserved. Unlike black-box finite differences, no additional randomness is introduced, avoiding a tradeoff between variance and bias.

Additionally, the primal-conditioned derivatives disclosed herein propagate well in many cases, including through functions that are highly non-linear (e.g., on the range of a random variable) and through loops of variable length. This feature permits automatic differentiation of the stochastic program, both forward and backward.

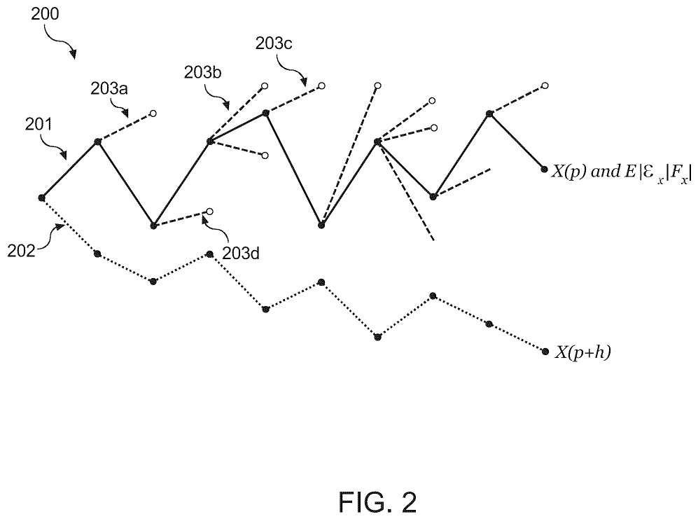

FIG. 2 depicts an illustration of the method according to an embodiment of the subject matter described herein. Referring to FIG. 2, the primal computation (i.e., top solid line 201) samples X(p). Black-box finite differences independently samples X(p+h) (i.e., bottom dotted line 202) for some finite choice of h. In contrast, conditionally expected differentials are coupled to the primal computation, considering the effect of the minimal possible perturbation (e.g., dotted lines 203a, 203b, 203c, and 203d, coming from the top solid line 201) to each step. These perturbations are propagated into an unbiased estimate for the expected stochastic differential E[E_{X}]=E[X(p+h)−X(p)] for infinitesimal h, where the estimate is conditioned on the σ-algebra F_{X}, representing knowledge of the trajectory of the primal computation.

It is appreciated that the method illustrated in FIG. 2 can be implemented using only a few lines of additional code to handle a random draw from a discrete distribution. This allows for differentiable stochastic programming.

The systems and methods of differentiable stochastic programming disclosed herein can be used in many applications. These include an inhomogeneous discrete random walk, rejection sampling, and the discrete resampling of a particle filter. The systems and methods of differentiable stochastic programming disclosed herein can also be applied to many stochastic programs where differentiation was previously thought intractable, such as jump processes, Gillespie simulations, and neural jump stochastic differential equations.

Primal-Conditioned Stochastic Infinitesimals: Stochastic Infinitesimals

In one embodiment of the systems and methods described herein, the reparameterization trick is generalized to handle discrete randomness. It should be noted that this discussion uses the language of non-standard calculus, letting e be an infinitesimal quantity of magnitude smaller than each fraction 1/n, n∈N.

A stochastic program is a program that, when provided with input p, gives a random output X(p). The stochastic program X(p) is parameterized over a continuous sample space Z. To obtain a single sample of the stochastic program, referred to as the “primal evaluation,” imagine a number z being randomly chosen from Z to produce a then deterministic output X(p)(z). A stochastic infinitesimal describes how the distribution of X(p) reacts to an infinitesimal change in the input.

For example, a Bernoulli random variable with probability p can be represented by picking a uniform random number z∈[0, 1] and defining X(p)(z)=1[1−p,1](z) where 1Ω(z) is the indicator function for z∈Ω. Note that parameterizations of many distributions over a continuous sample space Z can be constructed via the inversion method.

A stochastic infinitesimal is the change in a random variable with respect to an infinitesimal change in its input. Let F represent an infinitesimal change to the program's input. Then, dX is a stochastic infinitesimal for X(p) at input p if dX=X(p+ε)−X(p) where the dependence of dX on p is suppressed. This differs from finite differences in that ε is infinitesimal, X(p+ε) and X(p) share the same sample space, and they are typically not independent. A stochastic infinitesimal dX is then itself a random variable over the same sample space. For the full user-provided stochastic program, it is desirable to compute ∂ₚE[X(p)], which is related to E[dX] by E[dX]=∂ₚE[X(p)]·ε.

However, if the stochastic program X(p) represents the computation of an intermediate value of a larger program, or a single random building block of a program such as a draw from a Bernoulli variable, it does not suffice to compute just E[dX]. In order to develop a composable notion of derivative for stochastic programs, more information is needed about the distribution of dX. These distributional properties are also used to create unbiased estimators.

Consider the distribution of dX for two illustrative examples: a program returning a sample from the continuous exponential distribution Exp(p) and a program returning a sample from the discrete Bernoulli distribution Ber(p), both parametrized via the inversion method over the sample space [0, 1].

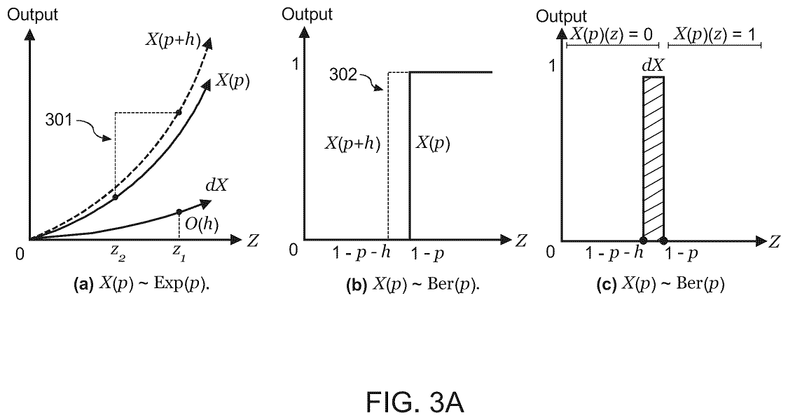

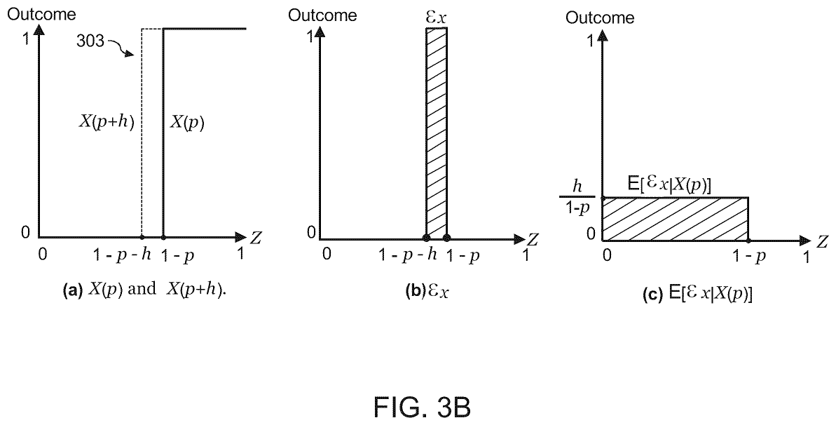

FIG. 3A illustrates a comparison of the change X(p+h)−X(p) for outputs with continuous and discrete distribution. A small finite P is used to represent an infinitesimal ε. Charts (a), (b), and (c) of FIG. 3A illustrate the change in output for given z caused by changing p to p+h. Line 301 of chart (a) in FIG. 3A indicates, in contrast, the effect caused by both changing p to p+h and sampling a new value z′ from the sample space. In the discrete case, only those z below the hatched area cause a non-zero change in output. The hatched area corresponds to the expected size of a change for randomly drawn z.

In the differentially parametrized continuous case (chart (a) of FIG. 3A), an infinitesimal perturbation in the input p results in an infinitesimal change of the outcome X(p)(z) (point-wise in z). This provides the basis for the familiar reparameterization trick. In this case, X(p)(z)=−p log(1−z) is differentiable in p for any fixed z. Thus, the value of dX(z) is O(ε) and E[dX]=O(ε), as expected.

There is another way that dX can have infinitesimal expectation, as shown in the discrete case. When one infinitesimally perturbs the probability p of a Bernoulli variable reparametrized using the indicator function as X(p)(z)=1[1−p,1](z) (letting h become small in chart (b) of FIG. 3A, as shown by line 302), the output at each noise value likely does not change. Instead, dX assumes a finite value of magnitude 1 with infinitesimal probability h (see chart (c) of FIG. 3A). This is the challenge presented by discrete randomness: an infinitesimal change in the input turns into what is referred to as a “finite infinitesimal.” A finite infinitesimal is a finite change that occurs with infinitesimal probability, contributing to the infinitesimal expectation of E[dX].

Primal-Conditioned Stochastic Infinitesimals: Coupling to the Primal

To produce low-variance estimates of the derivative of X(p), it is important that the primal and derivative computations are coupled by common random numbers. In a scenario in which the primal and derivative computations are entirely uncoupled, a black-box finite difference approach would independently sample z₁ and z₂ from the sample space, and compute for finite h the derivative estimate 1/h·(X(p+h/2)(z₂)−X(p−h/2)(z₁)). But the variance of these samples is O(1/h²), which goes to infinity as h goes to 0, forcing a variance-bias tradeoff.

In the case of purely continuous randomness, the reparameterization trick surmounts this issue by differentiating X(p) at a fixed value of the noise z (FIG. 3A). In the language of stochastic infinitesimals, this is equivalent to sampling directly from dX. But, referring to graph (c) of FIG. 3A, it can be seen how this is impossible in the discrete case. The stochastic infinitesimal dX is non-zero with infinitesimal probability, and thus the reparameterization trick likely returns 0, while the true derivative is ∂ₚ (“mean of Ber(p)”)=∂ₚp=1.

The systems and methods described herein operate by generalizing the reparameterization trick to the discrete case. First, consider the conditional distribution of dX given the primal output (i.e., its primal-conditioned distribution). By including finite infinitesimals, the primal-conditioned distribution can be explicitly represented. This eliminates the need for continuous relaxations and a variance-bias tradeoff.

Given a stochastic program X(p) satisfying certain formal conditions, and a primal output x, values δ, (Δx₁, w₁), (Δx₂, w₂), . . . , (Δxₙ, wₙ) can be found such that there exists a stochastic infinitesimal dX with a property, which, conditionally on X(p)=x, takes value Δxᵢ with probability wᵢ·ε each (with wᵢ·ε≈0) and δ·ε with the remaining probability 1−Σᵢ wᵢ·ε≈1.

The primal-conditioned distribution of dX for each random building block of the program is derived and the rest follow by compositionality. This is desired for the automatic differentiation of general stochastic programs. The representation is explicitly constructed. For continuous randomness, the reparameterization trick is recovered, as there is a one-to-one correspondence between input noise and primal output. Consider two examples of discrete random variables.

In a Bernoulli variable example, suppose X(p)˜Ber(p), parametrized via the inversion method. Consider the case of infinitesimal h>0 for simplicity. As shown in box (c) of FIG. 3A, dX is parameterized as

$$d X ( z ) = \{ \begin{matrix}1 & if 1 - p - h < z < 1 - p , \\ 0 & otherwise .\end{matrix}$$

The primal-conditional distribution of dX is then,

$$\{ \begin{matrix}Ber ( \frac{h}{1 - p} ) & if X ( p ) = 0 , \\ deterministically 0 & if X ( p ) = 1.\end{matrix}$$

Thus, if the primal output of X(p) is 0, then a positive infinitesimal change in the probability p results in an infinitesimal chance h/(1−p) of the Bernoulli variable flipping from 0 to 1.

In a geometric variable example, suppose X(p)˜Geo(p), where the number of failures are counted and parametrized via the inversion method. For h>0, the primal-conditioned distribution of dX can be derived as

$$\{ - Ber ( \frac{k + 1}{p} \cdot h ) \qquad if X ( p ) = k$$

In one exemplary embodiment, a technique of automatic differentiation is extended to handle continuous and discrete randomness. Specifically, rule-based automatic differentiation is extended based on conditional infinitesimal perturbation analysis.

Taking conditional expectations of pathwise derivatives enables the extension of forward and backward automatic differentiation to make stochastic programs automatically differentiable in expectation with respect to their parameters with minimal adaptions. The local smoothing properties of conditional expectations allows differentiating pathwise through important discrete stochastic transitions, such as the resampling step of a particle filter. For a wider class of programs, the approach gives an approximation of the derivative improving upon mean field approximations.

In an embodiment, the systems and methods described herein provide a fully differentiable particle sampler computing a marginal likelihood. This allows computing maximum likelihood estimates using stochastic gradient descent in high dimension and including full posteriors using piecewise deterministic Monte Carlo with stochastic gradients.

As mentioned previously, a stochastic program X(p) produces a non-deterministic quantity depending on input parameters p using a source of randomness. Formally, X: p→X(p) is a random map. Repeatedly sampling the output of a stochastic program allows estimation of quantities of interest, which can be formulated as expected value EX(p) of its output.

Next, suppose X(p) is a stochastic program with parametrized by a real interval, whose output belongs to a Euclidean space E. The triple of random variables (δ, w, Y) with infinitesimal change δ∈E, importance weight w≥0 (w≤0) and alternative outcome Y∈E is a right (left) derivative of X at the input p if for all smooth bounded real functions ƒ.

$$\frac{\partial }{\partial p} 𝔼 [ f ( X ( p ) ) ] = 𝔼 [ {f}^{′} ( X ( p ) ) \cdot δ + w ( f ( Y ) - f ( X ( p ) ) ) ]$$

Given a sufficiently regular stochastic program X(p) with

$${X}^{′} ( p ) = \frac{\partial }{\partial p} X ( p )$$

almost surely defined, there exists a weight function w≥0 on E and random program Y such that the triple (X′(p), w(X(p)), Y(X(p))) is a stochastic right derivative of X at p. Likewise there exists such a triple with w≤0 giving a left derivative. X′(p) represents the point-wise differentiation performed by a naive application of the reparameterization trick. Note that the importance weight of this part is (infinitely close to) 1. The second term corrects this estimate by including the effect of finite perturbations: for an output x of X(p), Y(x) is a random variable whose distribution encodes all possible finite perturbations present in the conditional distribution of dX given X(p)=x. Specifically, if a finite perturbation Δxᵢ occurs with infinitesimal probability wᵢε, then Y(x) takes value x+Δxᵢ with probability wᵢ/w, where w(x)=Σᵢ wᵢ. Crucially, infinitesimal probabilities have been replaced by finite ones, so that Y(x) can be easily sampled. Opting for left or right derivatives here may give different, but unbiased estimators.

The infinitesimal part and all finite perturbations can be separately considered. This is made possible by a form of “exclusion principle” for stochastic infinitesimals. Specifically, the event of two finite perturbations occurring simultaneously can be neglected because it has probability O(ε²). In addition, a O(ε) infinitesimal change can also be neglected in the event of a O(1) change with infinitesimal probability.

Only the conditional distribution of dX needs to be derived for each elementary stochastic program from which the full stochastic program is composed. Others may follow from compositionality, i.e., a stochastic derivative “chain rule,” as described in greater detail below.

The value of coupling to the primal is that it allows for consideration of only the smallest possible changes to the program output in the derivative computation, and thereby achieves variance reduction without resorting to continuous relaxations. For example, for a binomial variable X(p)˜Bin(n,p) parameterized via the inversion method, dX ∈{−1, 0, 1}irrespective of n. The variance of the gradient estimator for such a binomial variable is O(n), whereas the score function estimator has variance O(n³).

Composable Stochastic Derivatives: Composition

The above discussion defines the notion of a stochastic derivative and shows existence of a stochastic derivative for elementary stochastic programs. Composition will now be discussed. It should be noted that the cases of a purely continuous and purely discrete stochastic program are considered.

Consider stochastic programs X₁(p) and X₂(x₁), where X₁ has a stochastic derivative given by (δ₁, w₁, Y₁) and X₂ has a derivative (δ₂, 0, 0), as discussed above. Then X₂ ∘X₁ has a stochastic derivative given by (X₂(δ), 0, 0).

The key to composition is the case where X₂ is discrete random: here, an infinitesimal perturbation to the input of X₂ leads to finite perturbations, introducing another event with infinitesimal probability to be considered by the stochastic derivative.

Consider stochastic programs X₁(p) and X₂ (x1), where X₁ has a stochastic derivative given by (δ₁, w₁, Y₁) and X₂ has a derivative (0, w₂, Y₂), as discussed above. Then the stacked program [X₁; X₂ ∘X₁] has a stochastic derivative given by ([δ; 0], w, Y) where

$$Y = \{ \begin{matrix}[ {Y}_{1} ; {X}_{2} ( {Y}_{1} ) ] & with probability & \frac{{w}_{1}}{{w}_{1} + {w}_{2} ( {X}_{1} )} \\ [ {X}_{1} ; {Y}_{2} ( {X}_{1} ) ] & with probability & \frac{{w}_{2} ( {X}_{1} )}{{w}_{1} + {w}_{2} ( {X}_{1} )}\end{matrix}$$

$$and w = {w}_{1} + {w}_{2} ( {X}_{1} ) .$$

Composable Stochastic Derivatives: Smoothing

For discrete random variables, the reparameterization trick is deterministically 0, while stochastic derivatives fully capture potential finite perturbations with infinitesimal probability. There exists a middle ground between these methods: the conditional expectation of the stochastic infinitesimal dX, may be taken such that the derivative has the correct expectation given the primal output, but a finite perturbation by an infinitesimal one. By the tower property of conditional expectation, if δ+w(Y−X(p)) is an unbiased estimate of ∂ₚE[X(p)], then so is the random number \tilde{δ}=E[δ+w(Y−X(p))|X(p)]. If the function ƒ is approximately linear in X(p) over the range of X(p)+Y, even ∂ₚEf(X(p))≈Ef′(X(p))\tilde{δ}.

Smoothed stochastic derivatives enjoy limited composition properties. For example, assuming w₁=0, let δ₂=w₂(X₁)E[Y₂(X₁(p))|X₁(p)]. Then for functions ƒ that are linear:

$$\frac{\partial }{\partial p} 𝔼 f ( ( {X}_{2} ∘ {X}_{1} ) ( p ) ) = 𝔼 [ {f}^{′} ( ( {X}_{2} ∘ {X}_{1} ( p ) ) ) {\tilde{δ}}_{2} ]$$

Primal-Conditioned Derivatives: Existence and Unbiasedness

The systems and methods described herein introduce a primal-conditioned derivative for a stochastic process X(p). Imagine a noise z, representing all randomness involved in the program, being drawn a noise space to produce a deterministic output X(p)(z).

To motivate primal-conditioned derivatives, the classical quantities

$$\frac{\partial E [ X ( p ) ]}{\partial p} and \frac{\partial }{\partial p} X ( p )$$

can both be expressed as conditional expectations

$${\partial }_{p \pm \vert ℱ} X ( p ) := \frac{\partial }{\partial p \pm } 𝔼 [ X ( p ) \vert ℱ ]$$

for different choices of the σ-algebra F. Here, ∂_{p+|F} and ∂_{p-|F} are defined to represent right-sided and left-sided conditionally expected derivative operators. Conditionally expected derivatives are themselves random variables. An equation involving random variables should be thought of as holding true for all choices of the noise z. To understand the meaning of the equation for a single primal evaluation, imagine evaluating the random variables on a particular noise z.

Thus, F encapsulates some partial knowledge of the noise. At one extreme, the choice F=σ(Z) provides full knowledge of the noise, so that ∂_{p|σ(z)}X(p)=∂∂pX(p) differentiates X(p)(z) point-wise at each noise value z. This represents the reparameterization trick, which works when

$$\frac{\partial }{\partial p} X ( p )$$

is well-defined. At the other extreme, the choice F={Ø, Ω} provides no knowledge of the noise z, so that ∂_{p|{Ø,Ω}}

$$X ( p ) = \frac{\partial E [ X ( p ) ]}{\partial p} .$$

While this “mean value approximation” of the derivative is desired for the full stochastic program, if X(p) represents some intermediate value of the program, then knowing ∂p|{Ø,Ω}X(p) only allows propagating the derivative in the case of globally linear functions.

By choosing an F that is smaller than σ(Z), the differentiated random variable can be smoothed out, ensuring that ∂/∂p E[X(p)|F] exists and succeeding where reparameterization fails. In particular, [symbol] =σ(X(p)) is chosen, which conditions the derivative on the outcome of the primal evaluation. This allows forming an unbiased estimate of the derivative of E[X(p)]. On the other hand, the distribution of ∂_{p|X(p)}X(p) carries more information than the mean value approximation. This permits greater compositionality. The choice of F thus allows interpolating between the two extremes and, in particular, allows taking a derivative partly inside the expectation, but on an object which is smooth enough.

This primal-conditioned derivative exists and is unbiased for random variables that are continuous, discrete, or mixtures thereof. Suppose that X(p) is a stochastic process with noise space Z˜U(0, 1]. Assume that the distribution of X(p) can be decomposed into an absolute continuous part with density gₚ and a pure point part, where {x: P(X(p)=x)>0} is the countable set of atoms of the distribution of X(p). Then, if the set of atoms only contains isolated points and if the boundaries of the intervals (aₓ(p), bₓ(p)]={z: X(p)(z)=x} are differentiable in p for all values x with P(X(p)=x)>0, then ∂_{p±|σ(X)}X(p):=∂/∂p±E[X(p^{↓})|X(p)] satisfies:

$$\frac{\partial 𝔼 [ X ( p ) ]}{dp \pm } = 𝔼 [ {\partial }_{p \pm \vert σ ( X )} X ( p ) ]$$

The noise parametrization of X(p) affects the form of the conditionally expected derivative. In practice, it is useful to parametrize X(p) by the inversion method:

X(p):=Fₚ⁻¹(Z)

Here Fₚ⁻¹(u)=inf{x: Fₚ(x)≥u} is the left continuous inverse of the right continuous distribution function Fₚ(x)=P(X≤x) for X˜Fₚ indexed by the parameter p.

The primal-conditioned derivative is derived for each random “building block” of the stochastic program. In general, after propagation the primal-conditioned derivative may be conditioned on more information than just X(p); the σ-algebra can be a superset of σ(X(p)). But this does not affect the expectation of the derivative, by the tower property of conditional expectations. Thus, primal-conditioned differentials are unbiased estimators of the true differential.

Consider Y(p)˜Bin(n,p) parametrized using the inversion method. Using the accuracy and precision the primal derivatives ∂_{p±|Y(p)}Y(p) as estimators of the derivative of the expectation, in this example

$$\frac{\partial }{\partial p} EY ( p ) = n ,$$

both primal-conditioned derivatives are unbiased with variance:

$$Var ( {\partial }_{p + \vert Y ( p )} Y ( p ) ) = \frac{np}{1 - p} , and Var ( {\partial }_{p - \vert Y ( p )} ) ) = \frac{n ( 1 - p )}{p}$$

Comparing with the score method, it gives the estimator:

$${\partial }_{score} Y ( p ) := \frac{Y ( p ) ( Y ( p ) - np )}{p ( 1 - p )}$$

which is also unbiased, but its variance

$$Var ( {\partial }_{score} Y ( p ) ) = {n}^{3} \frac{p}{1 - p} + 𝒪 ( {n}^{2} )$$

is growing with cubic rate in n.

The variance of the primal conditioned binomial is much smaller because the relative error

$$\frac{𝔼 {\partial }_{p \pm \vert Y ( p )} Y ( p )}{\sqrt{Var ( {\partial }_{p \pm \vert Y ( p )} Y ( p ) )}} ≍ \frac{1}{\sqrt{n}}$$

shrinks if n gets large.

This is related to infinitesimal changes in z possibly changing Y(p) by {−1, 1}. This is not infinitesimal, but small in comparison to if n gets Var(Y(p)) large. The following discussion further expands on this.

Primal-Conditioned Derivatives: Connection to Stochastic Differentials

A stochastic differential describes how a stochastic program X(p) reacts to infinitesimal changes in the input parameter p. Stochastic differentials are related to the composability of primal-conditioned derivatives.

FIG. 3B illustrates the effect of perturbing the probability of a Bernoulli variable X(p) with p=½ by an infinitesimal h>0 according to an embodiment of the subject matter described herein. In chart (b) and chart (c) shown in FIG. 3B, the expectation of the differential (equal to h) is given by the hatched area.

Let p∈R be real and h an infinitesimal change. If ƒ is a differentiable function, then Δ_{f}=ƒ(p+h)−ƒ(p) represents an infinitesimal change in ƒ, so that Δ_{f}/h=ƒ′(p). Analogously, ε_{X}=X(p+h)−X(p) defines a stochastic differential ε_{X}, which depends on p and h. Here, X(p+h) and X(p) belong to a joint distribution with the same noise space (whereas in finite differences, the samples from each would be independent). With that, ε_{X}/h is an unbiased estimator for the derivative of the expectation of X(p),

$$𝔼 \frac{{ε}_{X}}{h} = \frac{\partial }{\partial p} 𝔼 X ( p )$$

As the right-hand side is finite, ε_{X} is infinitesimal in expectation. This does not imply, however, that ε_{X} always assumes an infinitesimally small value.

As another example, for a stochastic differential of Bernoulli variable, suppose X(p)˜Ber(p), parametrized via the inversion method, so that X(p)(z)=1 when z>1−p and 0 otherwise and the noise input z is equipped with a uniform distribution. Then, assuming h>0 for simplicity, ε_{X} has distribution

$$\{ \begin{matrix}1 & if 1 - p - h < z < 1 - p \\ 0 & otherwise\end{matrix}$$

as illustrated in chart (a) and chart (b) shown in FIG. 3B. It is appreciated that ε_{X} is 1 with infinitesimal, but non-zero, probability.

Under modest assumptions on X(p), E[|ε_{X}|]=O(h) and, therefore, by Markov's inequality the probability that εₓ takes a non-zero non-infinitesimal value is infinitesimal by itself.

The reparameterization trick differentiates the program X(p) at a fixed value of the noise z. In the language of stochastic differentials, this is equivalent to sampling directly from ε_{X}. To make sampling tractable in the case of discrete randomness, ε_{X} is coarsened. This motivates, for h>0 (or h<0), the primal-conditioned differential

$$𝔼 [ {ε}_{X} \vert X ( p ) ] = h {\partial }_{\begin{matrix}p + \vert σ ( X ) \\ ( or p - )\end{matrix}} X ( p )$$

Since E[ε_{X}|X(p)] is constant over each output of X(p), its range is O(h), as it cannot take any finite value with infinitesimal probability, implying the existence of ∂_{rp|σ(x)}X(p). Unbiasedness follows from the tower property (i.e., conditioning on partial information does not change the expectation).

[symbol]

[ε_{X}]= [symbol] [ [symbol] [ε_{X}|X(p)]]

As another example, for a conditionally expected differential of Bernoulli variable, suppose that X(p)˜Ber(p), parametrized using the inversion method. Then, for h>0, E[ε_{X}|X(p)] has distribution

$$h {\partial }_{p + \vert X} X ( p ) = \{ \begin{matrix}h / ( 1 - p ) & if X ( p ) = 0 \\ 0 & if X ( p ) = 1\end{matrix}$$

as shown in chart (c) of FIG. 3B.

Similarly, for h<0, E[ε_{X}|X(p)] has distribution

$$\partial {h}_{p - \vert X} X ( p ) = \{ \begin{matrix}0 & if X ( p ) = 0 \\ h / p & if X ( p ) = 1\end{matrix}$$

While ε_{X} assumes a non-zero value with infinitesimal probability, the coarsened random variable E[ε_{X}|X(p)] instead assumes an infinitesimal value with finite probability, making the sample tractable. It is further appreciated that E[E[ε_{X}|X(p)]]=h, which is precisely E[ε_{X}].

Primal-conditioned derivatives arise from conditioning on the differential ε_{X}. In particular, when considering composition, ε_{X} can have finite range, even when h is infinitesimal. By using the inverse of the distribution function to parametrize the noise dependence, the range of ε_{X} is made to be as small as the distribution of X(p) allows, as small changes in p will trigger incremental changes in the outcome of X(p) (e.g., one more failure for a geometric variable).

Automatic Differentiation Using Stochastic Duals: Composition

A weight function w and discrete random program Y both take the output of X(p) as input such that for all smooth real-valued functions ƒ

$${\partial }_{p} 𝔼 f ( X ( p ) ) = 𝔼 [ ∇ f ( X ( p ) ) {lim}_{ε \to 0} \frac{X ( p + ε ) - X ( p )}{ε} + \overline{w} ( X ( p ) ) ( f ( Y ( ( X ( p ) ) ) - f ( X ( p ) ) ) ]$$

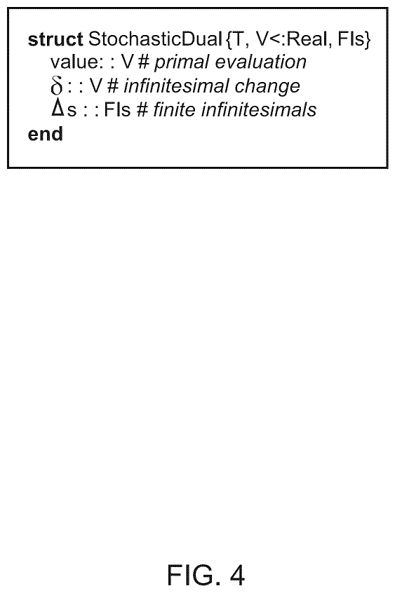

FIG. 4 depicts example source code for implementing a stochastic dual structure according to an embodiment of the subject matter described herein. The example source code shown in FIG. 4 may be integrated as part of the systems disclosed herein to implement the methods described herein.

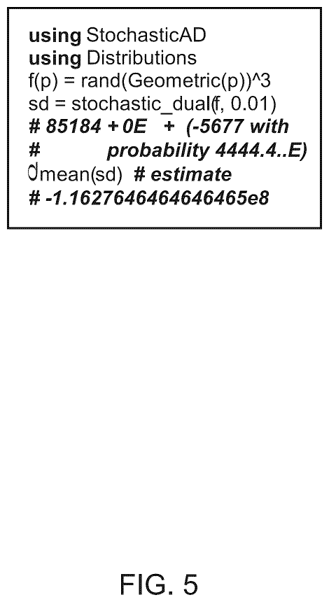

FIG. 5 depicts example source code for obtaining an unbiased estimate of ∂ₚ Geo(p)³ according to an embodiment of the subject matter described herein. The example source code shown in FIG. 5 may be integrated as part of the systems disclosed herein to implement the methods described herein.

Dual numbers, which pair the primal evaluation of a deterministic function ƒ(p) with its derivative ∂ₚƒ(p), are a fundamental concept in the AD of deterministic programs. Deterministic AD is a consequence of how these dual numbers compose. The systems and methods described herein develop a stochastic dual number that generalizes dual numbers to stochastic programs X(p).

First, therefore, in addition to an infinitesimal component, the stochastic dual can store finite infinitesimal(s). Second, the stochastic dual can be coupled to the primal computation.

The stochastic dual structure, shown above, consists of the result of the primal evaluation, an infinitesimal component (abbr. δ), and a set of (conditionally) independent finite infinitesimals (abbr. Δs). A finite infinitesimal Δ associates a finite change Δx with an infinitesimal event occurring with probability w·dp. Together, δ and Δs form a representation of the stochastic infinitesimal conditioned on the primal trajectory Fₓ, where Fₓ is formally a σ-algebra that captures knowledge of the outputs of each random step of the primal evaluation.

To perform forward differentiation, a stochastic dual with value p and infinitesimal part 1 are inputted into the program. After the stochastic dual propagates through the full program, the δ and Δs components are collapsed into their expectation to form the derivative estimate. Thus, unbiasedness follows by the tower property of conditional expectations, E[E[dX|F_{X}]]=E[dX], and thus stochastic duals produce unbiased derivative estimates.

Automatic Differentiation Using Stochastic Duals: Composition: Propagation Through Unary Functions

Below is described how an infinitesimal δ and a finite infinitesimal Δ are transformed when a stochastic dual propagates through a unary function. While deterministic AD is concerned only with a ∂→∂ rule, where an infinitesimal change in the input leads to an infinitesimal change in the output, the δ→Δ A transition that occurs for discrete random variables is notable because this links infinitesimal changes to finite changes. Δ→Δ rules may be implemented to perform unbiased AD with stochastic duals.

Automatic Differentiation Using Stochastic Duals: Composition: Propagation Through Continuous Functions ƒ(p).

δ→δ: The case of an infinitesimal input to a continuous function is handled by standard AD.

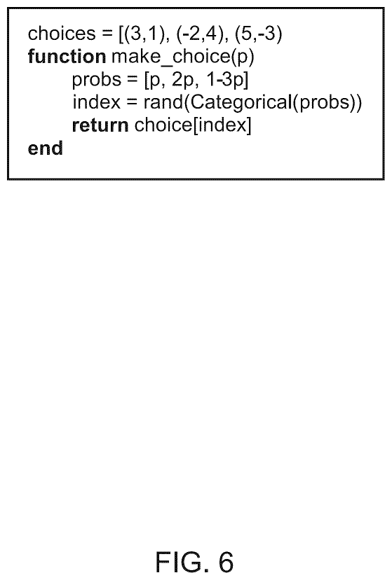

FIG. 6 depicts example source code for implementing an idiom for making a discrete choice in a program according to an embodiment of the systems and methods described herein. The example source code shown in FIG. 6 may be integrated as part of the systems disclosed herein to implement the methods described herein.

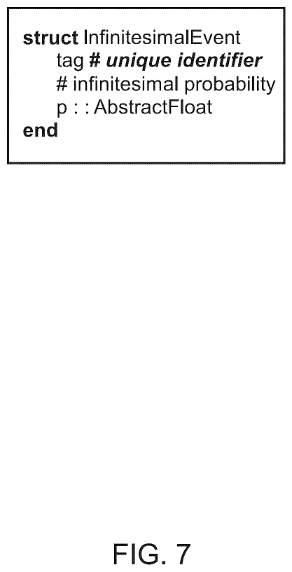

FIG. 7 depicts example source code for implementing a structure for an infinitesimal event according to an embodiment of the systems and methods described herein. The example source code shown in FIG. 7 may be integrated as part of the systems disclosed herein to implement the methods described herein.

Δ→Δ: The discrete derivative of ƒ(p) is computed, found as ƒ(p+Δp)−ƒ(p) where Δp is the finite change associated with input Δ. Another Δ associated with the same infinitesimal event as the input Δ is outputted.

This rule also handles continuous random functions X(p) with the reparameterization trick, as ƒ(p)=X(p)(z) for fixed z is a continuous function.

Automatic Differentiation Using Stochastic Duals: Composition: Composition Through Discrete Random Functions X(p)

δ→Δ: A new infinitesimal event (or possibly more than one) is created. The output Δ is associated with this event and the form of the A is computed.

Δ→Δ: The parameter of the discrete distribution is shifted by a finite amount and the restriction of the shifted distribution to the primal sample space is considered. However, for a single input Δ, there could be multiple possible output Δs, increasing computational cost. Exploiting further stochasticity to avoid this while remaining unbiased is achieved by sampling a random noise z from the primal sample space of X(p), and output the Δ corresponding to this choice of z, associated with same infinitesimal event as the input Δ.

Automatic Differentiation Using Stochastic Duals: Composition: Composition Through Discrete Functions k(p)

Δ→Δ: Discrete functions k(p) where only discrete changes to the input are possible can be handled analogously to the Δ→Δ rule for continuous functions. To enable propagation through discrete functions, such as array indexing, accurate type information is maintained. Stochastic duals accomplish this by faithfully preserving all discrete structure in the original program: if a quantity in the primal evaluation is an integer, the stochastic dual will have type StochasticDual{T, Int, FIs}. This enables AD of code such as the idiom shown above.

Automatic Differentiation Using Stochastic Duals: Composition: Linking Stochastic Duals Together

A multivariate function g(X₁(p), . . . , Xₘ(p)) can be thought of as a unary function with the tuple input (X₁(p), . . . , Xₘ(p)).

Therefore, stochastic duals can be linked into a tuple to handle multivariate functions. By the total differential rule for stochastic infinitesimals, the effect of each independent finite infinitesimal Δ present amongst the m stochastic duals can be separately considered. However, there is no guarantee that the Xᵢ(p) are independent, and so it may be the case that Δs of different stochastic duals were caused by the same infinitesimal event. To handle this, each A is associated with a uniquely-identified infinitesimal event in StochasticAD.j1 (shown previously above). Linking of stochastic duals is then performed by grouping together Δs corresponding to the same infinitesimal event and considering their combined effect. This is akin to a tagging system for traditional forward-mode AD.

Automatic Differentiation Using Stochastic Duals: Pruning and Smoothing

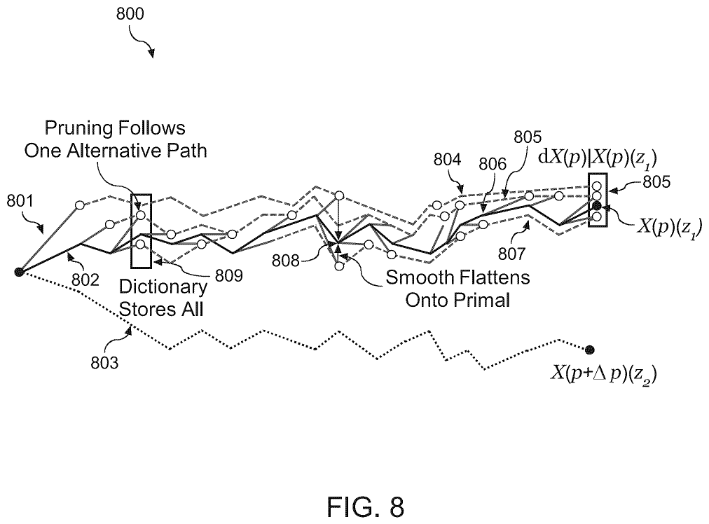

Different backends for storing the set of Δs are permitted. Each implements an abstract interface for creating a new Δ, performing a map operation on Δs, and linking together different sets of Δs. FIG. 8 shows a sketch of the approaches discussed below.

In FIG. 8, the finite infinitesimals Δs can bethought of as tracking a set of “alternative” paths to the primal computation X(p)(z₁). Unlike finite differences (bottom) which computes X(p)(z₂) for independent z₂, these alternative paths are tightly coupled to the primal computation (e.g., dotted lines 804, 805, and 807). The dictionary backend 809 stores all paths, while the pruning backend picks one at random, and the smoothing backend turns Δs into traditional infinitesimals of equal expectation.

Dictionary. In one embodiment, the Δs are stored in a dictionary, with infinitesimal events as keys and the finite changes as values. This approach may be implemented in the DictFIs<:AbstractFIs backend. However, this may introduce heap allocations and, furthermore, the overhead of the derivative computation may no longer be guaranteed to be O(1) when the set of Δs is large.

Pruning. In one embodiment, the set of Δs are pruned because an unbiased estimate of the derivative only needs to be formed. Specifically, given Δ₁ with probability p₁h and Δ₂ with probability p₂h, a Δᵢ for i∈{1, 2} can be chosen randomly, where the probability of choosing Δᵢ is weighted by pᵢ. The probability of the chosen Δᵢ can then be replaced with (p₁+p₂)h. This technique is similar to importance sampling [ ]. By pruning aggressively each time a new infinitesimal event is considered, the set of Δs always remains size 1. In other words, the pruning backend PrunedFIs<:AbstractFIs is a wrapper around a single Δ. This makes the pruning backend type stable [ ], avoiding heap allocations and ensuring a constant-factor overhead.

Smoothing. In one embodiment, no Δs are stored at all, instead “smoothing” a Δ with finite change Δx and probability p·h into an infinitesimal change Δx·p·h, which has the same expectation. Unlike pruning, smoothing is only unbiased under the condition that functions are linear over the set of alternative primal values. For discrete (or discrete random) functions, this corresponds to assuming that output will not jump up or down by two discrete steps in the primal-coupled derivative computation. For continuous functions, this condition will generally only hold approximately, but still leads to low bias estimates in a number of cases. For example, taking p=1/100 such that Geo(p) has inter-quartile range [28, 137], smoothed stochastic duals give a derivative estimate with <0.5% bias on the stochastic program Geo(p)³.

Furthermore, smoothed stochastic duals can be applied to compute exactly unbiased estimates in certain settings, as shown for the resampling step of a particle filter, where particles having a small weight are dropped using Bernoulli variables. An infinitesimal increment of the weight has an infinitesimal (non-negligible) probability of turning a zero weight positive would mean that particles with a weight of zero would have to be tracked, making the particle sampler inefficient or useless. By choosing the signed left derivative (h<0), however, an unbiased, primal-conditioned derivative is obtained with the property that particles ending in zero weight have a derivative of zero. Therefore, these particles can be entirely neglected for calculations of expected values of the primal sampler and its derivative. This is accomplished in a stochastic program using the definition of a formally differentiable weight function:

newweight(p)=1.0

newweight(p::Dual{T}) where {T}=Dual{T}(1.0,partials(p)/value(p))

Pruned stochastic duals are unbiased in all cases and have O(1) overhead. For reverse-mode AD, smoothed stochastic duals may be used. This is because how to backpropagate a pruned stochastic dual requires knowledge of alternative paths, which may have branched off much earlier in the computation. On the other hand, smoothed stochastic duals are functionally equivalent to standard dual numbers as they contain only an infinitesimal part. This enables reverse-mode stochastic AD using the existing infrastructure for deterministic reverse-mode AD.

Composition: Propagation of Primal-Conditioned Derivatives

It is desirable for derivatives to compose. As described below, an advantage of primal-conditioned differentials is that they encode enough information to propagate well in many applications, enabling a natural extension of automatic differentiation, both forward and backward, to stochastic programs.

A propagated primal-conditioned derivative for a stochastic program X(p) is conditioned at the minimum on the outcome. However, as described below, a derivative that is propagated through intermediate computations will condition on the outputs of these computations, too. Thus, derivatives _{∂p|F}X(p), where F is generated over X(p) and all intermediate random variables used to sample X(p). As a result, F can represent knowledge of the trajectory of the primal computation (i.e., the outcome of each random step) which created X(p).

Primal-conditioned derivatives obey analogues of the sum and product rules. For stochastic processes X(p), Y(p) and σ-algebras F_{X}, F_{Y},

[symbol]

(X+Y)(p)= [symbol] X(p)+ [symbol] Y(p)

Also, under assumption of independence of X and Y,

[symbol]

(XY)(p)=Y(p)· [symbol] X(p)+X(p)· [symbol] Y(p)

The sum rule follows from linearity of expectation, while the product rule falls out by the usual argument, after using independence to exploit the total differential rule.

In another example, consider the sum Y(p)=Σᵢ₌₁ⁿXi(p) of n independent Bernoulli variables Xᵢ with parameter ₚ. Using complete primal information F=σ(X₁, . . . , Xₙ), the unbiased estimator is obtained:

$${\partial }_{p + \vert ℱ} Y ( p ) := {\sum }_{i = 1}^{n} {\partial }_{p + \vert {X}_{i}} {X}_{i} ( p ) = \frac{n - Y ( p )}{1 - p}$$

with expected value

$$n = \frac{\partial }{\partial p} EY ( p )$$

and variance

$$Var ( {\partial }_{p + \vert ℱ} Y ( p ) ) = n \frac{p}{1 - p}$$

But neither the sum nor the product rule exploits any properties of the information that the differentials are conditioned on. Below is a chain rule for primal-conditioned differentials.

Consider the program (Y∘X)(p) where both X and Y are possibly random. The below discusses when it is valid to first obtain the primal-conditioned derivative of X(p) with respect to p and then substitute it into the primal-conditioned derivative of Y(X(p)) with respect to the outcome of X(p).

A possibly-random function Y, applied to a stochastic program X(p), is locally linear if E[Y(x+d)−Y(x)|Y(x)=y] is a linear function of d for d in the range of εₓ, for all primal outputs x and y.

Chain Rule. For a random function Y that is locally linear on stochastic process X(p), and a σ-algebra F_{X}⊇σ(X(p)):

[symbol]

(Y)(Y∘X(p))=∂_{x|σ(Y)}Y(x)|_{x=X(p)}· [symbol] X(p)

Thus,

$$\begin{matrix}𝔼 [ {ε}_{{Y}^{∘} X} \vert {ℱ}_{X} , Y ( X ( p ) ) ] = 𝔼 [ Y ( X ( p + h ) ) - Y ( X ( p ) ) \vert {ℱ}_{X} , Y ( X ( p ) ) ] \\ = 𝔼 [ Y ( X ( p ) + {ε}_{X} ) - Y ( X ( p ) ) \vert {ℱ}_{X} , Y ( X ( p ) ) ] \\ = 𝔼 [ Y ( Xp ) + 𝔼 [ {ε}_{X} \vert {ℱ}_{X} ] ) - Y ( X ( p ) ) \vert {ℱ}_{X} , Y ( X ( p ) ) ] \\ = ( {\partial }_{x \vert σ ( Y ( p ) )} Y ( x ) ) {\vert}_{x = X ( p )} \cdot 𝔼 [ {ε}_{X} \vert {ℱ}_{X} ]\end{matrix}$$

where the penultimate equality follows from σ(X(p))⊆F_{X} and local linearity.

An special case occurs when the function is deterministic. A function g, applied to a stochastic program X(p), is locally linear if it is affine on the range of x+ε_{X} for all primal outputs x.

Chain Rule for Deterministic Functions. If g is locally linear on X(p),

[symbol]

(g∘X(p))=g′(X(p))· [symbol] X(p)

The relaxed assumption of local linearity, as opposed to global linearity, allows differentiating stochastic functions that are highly non-linear on the full range of X(p), as shown by the following example.

In an example of cubing a geometric variable, let X(p)˜Geo(p). For h>0, ε_{X}∈{0, 1} and ∂_{p|X(p)}X(p) has distribution

$$\{ - \frac{( k + 1 )}{p} if X ( p ) = k , for integer \geq 0$$

Take p=1/100 and consider X(p)³. X(p) ranges from 0 to ∞, with inter-quartile range [28, 137]. But since ε_{X}∈{0, 1}, the cube function is locally linear to a good approximation. So, using the chain rule an estimator is obtained of

$$\frac{d}{dp} E [ {x ( p )}^{3} ] ,$$

3X(p)²∂_{p|X(p)}X(p)

Using the right-handed derivative yields an estimate with <0.5% bias. In contrast, propagating the deterministic derivative ∂ₚE[X(p)] (the mean value approximation) leads to 67% bias. In many cases, functions will only be approximately locally linear.

Automatic Differentiation of Stochastic Programs: Stochastic Triples

In AD of deterministic programs, dual numbers pair the primal evaluation of a deterministic function ƒ(p) with its derivative ∂ₚƒ(p), enabling automatic forward differentiation via operator-overloading.

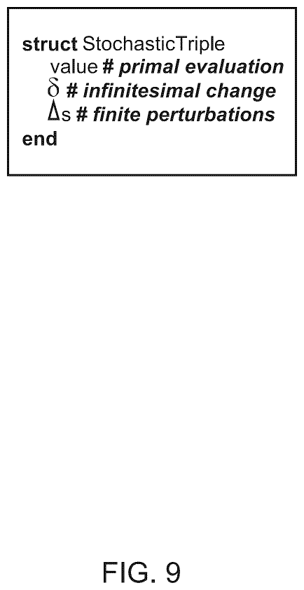

FIG. 9 depicts exemplary source code for an implementation of a stochastic triple structure (simplified) according to an embodiment of the systems and methods described herein. FIG. 9 presents the structure of stochastic triples, which generalize dual numbers to programs containing discrete randomness. For a random program X(p) with stochastic derivative (δ, w, Y), the stochastic triple stores the result x of the primal evaluation, alongside δ(x) and a sample from Y(x). The example source code shown in FIG. 9 may be integrated as part of the systems disclosed herein to implement the methods described herein.

To perform forward differentiation, rules for propagating this stochastic triple through elementary functions are used. A probabilistic choice is made between the two possible finite perturbations to produce the resultant stochastic triple, where the probability of picking a particular perturbation is weighted by its probability. The effect of the perturbation that is not chosen is no longer considered, such that after all propagation has completed, a single “alternative path” through the computation has been chosen for the derivative estimate. This strategy, referred to as “pruning,” relates closely to the idea of importance sampling, and ensures O(1) computational overhead of the stochastic triple while remaining unbiased.

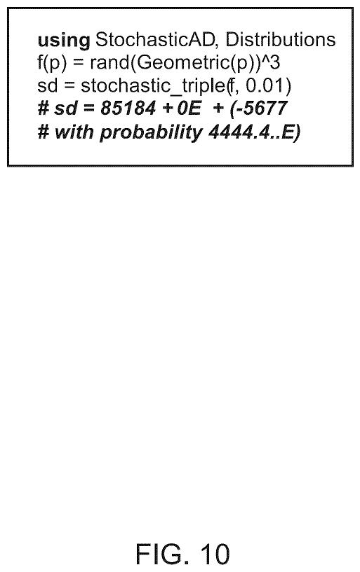

The stochastic triple propagates through a stochastic program via operator overloading, as shown in the image below. FIG. 10 depicts exemplary source code for propagating a stochastic triple through Geo(p)³ according to an embodiment of the systems and methods described herein. The example source code shown in FIG. 10 may be integrated as part of the systems disclosed herein to implement the methods described herein.

Afterward, the stochastic triple is collapsed into a single estimate of the derivative, resulting in a sample from the right-hand side with ƒ as identity function.

In addition to considering unary functions, complications arise with multivariate functions: a finite perturbation associated with a stochastic program X₁(p) may have stemmed from the same event with infinitesimal probability as a finite perturbation with a different stochastic program X₂(p). In this case they are linked and the opposite of the exclusion rule discussed herein holds: the two perturbations either happen in unison or not at all. To perform linking, each finite perturbation is associated with a uniquely-identified infinitesimal event, i.e., an event with infinitesimal probability. The systems and methods described herein incorporate the notion of linking into stochastic derivatives. With this innovation included, an unbiased estimate for the derivative of an arbitrary stochastic program is computed via forward-mode AD.

Composition: Automatic Differentiation

The systems and methods described herein provide for forward and backward differentiation of stochastic programs. For forward differentiation, the dual number (p, 1) is provided as input to the function. To handle randomness, a custom forward rule is supplied for random draws from a distribution, whereby the dual value is multiplied by the primal-conditioned derivative of this random building block. For all deterministic code, the dual number can be propagated through the standard rules for dual algebra, allowing for seamless integration into existing forward differentiation systems.

Composition: Asymmetry of Stochastic Differentials

If the expectation of the full program X(p) is differentiable in p, both the left-sided and right-sided primal-conditioned derivatives serve as unbiased estimates of the derivative, but they follow fundamentally different distributions.

In various embodiments, it may be useful to mix the two derivatives where the centered difference has an error an order of magnitude lower. Next, consider for X E R the weighted average of primal-conditioned derivatives λ· [symbol] X(p)+(1−λ)· [symbol] X(p).

The choice of λ can greatly reduce the bias of estimates, as described below. By linearity of expectation, λ can be chosen arbitrarily for each random building block, or even as function of p, without creating a bias or affecting composition. This leads to the following example.

In an example of a deterministic primal-conditioned differential for a Bernoulli variable, the weighted average of the left-sided and right-sided primal-conditioned derivatives of a Bernoulli variable is taken, with the choice λ=p, gives

$$\{ \begin{matrix}1 & if X ( p ) = 0 \\ 1 & if X ( p ) = 1\end{matrix}$$

Thus, a deterministic (primal-independent) dual value of 1 for a Bernoulli variable propagates well. This is different from the mean-value approximation, as the dual value may still accrue some randomness as it propagates through the program. This may not be possible for a geometric variable, as shown by the failure of deterministic dual values described above.

Finally, the choice of derivative direction can account for variable control flow. For example, if an input parameter is perturbed, a while loop may have a higher chance of running for one fewer iteration. To get the correct derivative, embodiments described herein may consider this sensitivity. This forms the basis for the efficient differentiation of a particle sampler described herein.

Primal-Conditioned Derivatives and Monte Carlo: Sequential Monte-Carlo

In a situation where X(p), with density fₚ, is difficult to sample from yet an approximation to the program, X(p) with density \tilde{ƒ}ₚ, is available and can be sampled from and assuming absolute continuity, that is

$$𝔼 \frac{{f}_{p} ( \tilde{X} ( p ) )}{{\tilde{f}}_{p} ( \tilde{X} ( p ) )} = 1 ,$$

for functionals g

$$𝔼 g ( X ( p ) ) = 𝔼 [ \frac{{f}_{p} ( \tilde{X} ( p ) )}{{\tilde{f}}_{p} ( \tilde{X} ( p ) )} g ( \tilde{X} ( p ) ) ]$$

Taking this is Feynman-Kac type representation of the expectation as starting point, consider the program which returns the pair of weight and value

(ω̅)(p),\tilde{X}(p))

where

$$\overline{ω} ( p ) = \frac{{f}_{p} ( \tilde{X} ( p ) )}{{\tilde{f}}_{p} ( \tilde{X} ( p ) )}$$

jointly. The ansatz ω̅ (p+h)ƒ(\tilde{X}(p+h))=(ω̅ (p)+ε̅)g(\tilde{X}(p)+ε) gives with the composition rules the following proposition: If g is locally linear on the range of \tilde{X}(p+h) and [symbol] [ε̅ε]/h is infinitesimal,

$$\frac{\partial }{\partial p} 𝔼 g ( X ( p ) ) = 𝔼 [ ( ϖ ( p ) + \overline{H} ) g ( \tilde{X} ( p ) + H ) ] \\ where \\ H = 𝔼 [ ε \vert \tilde{X} ( p ) ] and \overline{H} = 𝔼 [ \overline{ε} \vert ϖ ( p ) ]$$

Programs returning weighted samples can be monadically composed. If Eω̅ᵢ(xᵢ₋₁\tilde{X}ᵢ(xᵢ₋₁)=EXᵢ(ₓᵢ₋₁), i=1, 2, then

[symbol]

[X₂(X₁(p))]= [symbol] [ω̅₂(\tilde{X}(p))ω̅₁(p)\tilde{X}₂(\tilde{X}₁(p))]

by conditional independence. Note that the product \hat{ω}₂(\tilde{X}₁(p)) ω̅₁(p) is linear in each of its arguments ω̅₂(p) and ω̅₁(p).

The functorial nature of the transformation, which assigns each program part (represented by Markov kernels K) in a composed program (that is Bayesian network) an equivalent pair of changed transition kernels K and multiplicative weight change.

Finally, the formalism can be extended by having programs not return a single weighted sample, but a number of (not necessarily independent) weighted particles, that is samples \tilde{X}^{(k)} and corresponding weights ω̅^{(k)}, k∈{1, . . . , K}, such that

$$𝔼 g ( X ( p ) ) = {\sum }_{k = 1}^{K} 𝔼 [ {ϖ}^{( k )} ( p ) g ( {\tilde{X}}^{( k )} ( p ) ) ]$$

Feynman-Kac Playground:

[symbol]

g(X(p))= [symbol] ω̅(p)g(\tilde{X}(p)

Primal-Conditioned Derivatives and Monte Carlo: Central Limit Theorem for a Mixed Bernoulli Process

Quantifying the uncertainty related to estimating the derivative of an expectation from its primal-conditioned derivative in the case of a mixed Bernoulli process is described below. Let (pᵢ, hᵢ)ᵢ=1, . . . a sequence of independent identically distributed random dual probabilities with pᵢ real, hᵢ infinitesimal and Epᵢ=μ and Ehᵢ=μ_{∂} and Var(hᵢ)=σ∂² and Xᵢ(pᵢ) the dependent process of conditionally independent Bernoulli draws with conditionally expected left derivatives

$${H}_{i} = {1}_{{X}_{i} ( {p}_{i} ) = 1 \frac{{h}_{i}}{{p}_{i}}}$$

By independence of hᵢ and pᵢ, EHᵢ=μ∂. Thus, the convergence of

$$= \frac{1}{n} {\sum }_{i = 1}^{n} {H}_{i} \to {μ}_{\partial }$$

By the law of total variance,

$$Var ( {H}_{i} ) = 𝔼 [ Var ( {H}_{i} \vert ( {p}_{i} , {h}_{i} ) ) ] + Var ( 𝔼 [ {H}_{i} \vert ( {p}_{i} , {h}_{i} ) ] ) = {σ}_{\partial }^{2} ( 𝔼 [ \frac{1 - {p}_{i}}{{p}_{i}} ] + 1 )$$

and by the central limit theorem,

\sqrt{n}( [symbol] )−μ_{∂})→N(0,Var(Hᵢ))

in distribution, given that the expectation of odds

$$\frac{1 - {p}_{i}}{{p}_{i}}$$

and therefore Var(Hᵢ) is finite. Similarly, using a right derivative we obtain a variance depending on the inverse of the odds

$$Var ( {H}_{i} ) = {σ}_{\partial }^{2} ( E \frac{{p}_{i}}{1 - {p}_{i}} + 1 ) ,$$

so the choice of derivative plays an important role, in case the probabilities pᵢ are close to 0 or to 1.

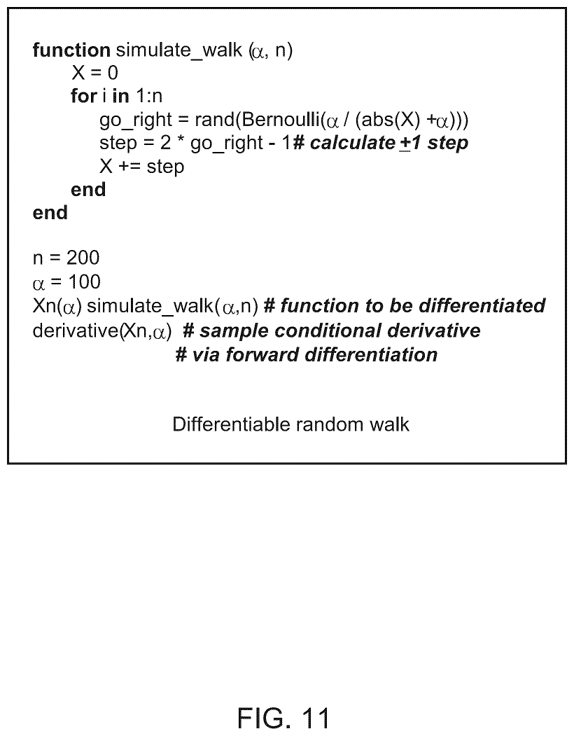

FIG. 11 depicts example source code for a differentiable random walk according to an embodiment of the subject matter described herein. The example source code shown in FIG. 11 may be integrated as part of the systems disclosed herein to implement the methods described herein.

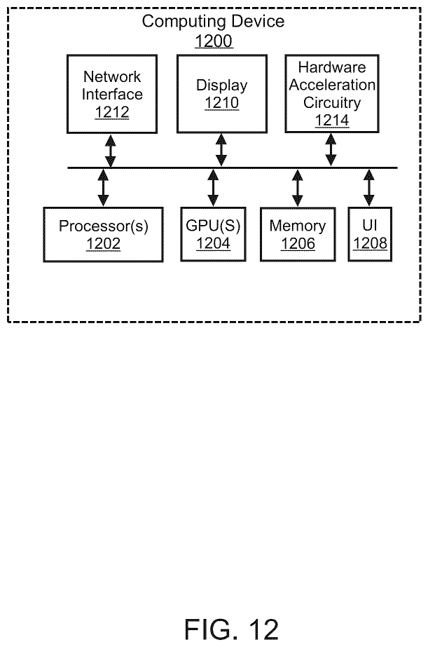

FIG. 12 depicts a block diagram illustrating one embodiment of a computing device that implements the methods and systems described herein. Referring to FIG. 12, the computing device 1200 may include at least one processor 1202, at least one graphical processing unit (“GPU”) 1204, a memory 1206, a user interface (“UI”) 1208, a display 1210, a network interface 1212, and hardware acceleration circuitry 1214. The memory 1206 may be partially integrated with the processor(s) 1202, the GPU(s) 1204, and/or the hardware acceleration circuitry 1214. The hardware acceleration circuitry 1214 may be specialized circuitry or hardware specific circuitry, such as an ASIC or FPGA. The UI 1208 may include a keyboard and a mouse. The display 1210 and the UI 1208 may provide any of the GUIs in the embodiments of this disclosure.

The methods described herein may be implemented on one or more computing devices, such as the computing device described in the context of FIG. 12. As described, in one embodiment, a programmatic method for performing language-level automatic differentiation of a stochastic program is disclosed. The programmatic method includes receiving a user-provided stochastic program. The programmatic method further includes generating a stochastic derivative based on the user-provided stochastic program. The programmatic method further includes generating an estimator for the user-provided stochastic program using the stochastic derivative. The estimator may be unbiased and/or automated. The estimator determines an estimate of a derivative of the user-provided stochastic program. The estimate of the derivative determined by the estimator may be applied to a simulation or other model to accelerate hardware running the simulation or other model. This method, as well as the other methods described herein, may be implemented on one or more computing devices.

In various contexts, the stochastic derivative may be generated on hardware-specific circuitry or hardware acceleration circuitry. Similarly, the estimator may be generated on hardware-specific circuitry or hardware acceleration circuitry.

In other embodiments, as described, a derivative of an expectation of a stochastic program is automatically determined. In various contexts, the derivative of the expectation of the stochastic program may be generated on hardware-specific circuitry or hardware acceleration circuitry.

Applications: Differentiating a Heterogeneous Random Walk

The derivative of a heterogeneous random walk can be sampled over the integers. Consider a Markovian random walk X₀, . . . , Xₙ depending on a parameter α>0 taking values in the integers with the following transition behavior:

$${X}_{n} \{ \begin{matrix}{X}_{n - 1} + 1 with probability \frac{α}{\vert {X}_{n - 1} \vert + α} \\ {X}_{n - 1} - 1 with probability \frac{\vert {X}_{n - 1} \vert}{\vert {X}_{n - 1} \vert + α}\end{matrix} , {X}_{0} = 0$$

By direct stochastic simulation, the final value, Xₙ, of the walk after n steps can be sampled. By propagating primal-conditioned derivatives, with the Bernoulli variable rule as our building block, this simulation can be augmented to sample the derivative of X with respect to a.

Consider a walk with n=200 steps. Through forward differentiation of primal-conditioned derivatives, unbiased samples of ∂E[Xn]/∂α (note that the left and right derivatives agree in this case) are obtained. The samples of ∂E[Xn]/∂α have mean μ≈0.456 and standard deviation σ≈0.01.

This method is contrasted with black box finite differences, which would sample from Xₙ⁽¹⁾(α+Δα)−Xₙ⁽²)(α) for some chosen Δα, where X⁽ⁱ⁾ are independent copies of the program. In choosing Δα=1, we already suffer a ±1% accuracy loss from linearization of E[Xₙ(α)]. Furthermore, samples from X(α+1)−Xₙ(α) have a standard deviation σ_{fd}≈11, ≈10³ times larger than that of the primal-conditioned derivatives. Thus, it would require≈(10³)²=10⁶ times more samples to achieve the same variance reduction in estimating ∂E[Xn]/∂α as the method of primal-conditioned derivatives.

The present method contrasts with explicitly computing the probability distribution function. We form the tridiagonal transition matrix M(α) of the random walk, and compute the probability density function as

M(α)ⁿ1ₓ₌₁

By applying automatic differentiation to the equation above, we obtain ∂E[Xn]/∂α in a deterministic manner. However, we emphasize the computational expense of this approach—in this case, M(α) is a 201×201 matrix (Xₙ ranges from 0 to n), which is applied iteratively n=200 times. In contrast, primal-conditioned derivatives can deal with high-dimensional (and even infinite-dimensional) probability density functions, with samples produced through standard automatic differentiation of the primal computation.

To conclude this example, first note that the Bernoulli probability α/(|Xᵢ|+α) is an approximately linear function on the domain of Xᵢ±ε{Xᵢ−1, Xᵢ, Xᵢ+1}, yet can still obtain accurate results compared to the true value of ∂E[Xn]/∂α (computed by differentiating the probability density function above), the mean μ of the primal-conditioned derivatives has≈0.2% error. Furthermore, suppose one were interested not merely in the derivative of E[Xₙ], but of a more complicated function, such as E[Xₙ²]. After n=200 steps, X will be close to α=100, and thus far from 1, with high probability. Thus, the function Xₙ² can be considered approximately linear on the domain of X±ε. The following addendum accurately computes

$$\frac{\partial }{\partial α} E [ {X}_{n}^{2} ] .$$

Y(α)=X_n(α)\hat{ }2

derivative (Y, α)

Empirically, the samples using primal-conditioned derivatives have a mean≈68.1 and standard deviation≈6. The mean μ approximates the true value of

$$\frac{\partial }{\partial α} E [ {X}_{n}^{2} ] . \approx 68.6$$

with <1% error.

Applications: Differentiable Rejection Sampling

Below is described how the choice of direction allows primal-conditioned derivatives to take derivative of functions with variable code path. This can be illustrated with the practical example of rejection sampling. Here, it is assumed that X(p) has a density fₚ, which is difficult to sample from, and \tilde{X} density \tilde{ƒ}. Assume ƒₚ(x)/\tilde{ƒ}(x)≤c≤∞. The idea of rejection sampling uniformly a pair u, x from the set {u, x: u≤fp(x)} obtained from samples via

[symbol]

X(p)= [symbol] [Y|U<ƒₚ(\tilde{X})/(c\tilde{ƒ}(\tilde{X}))]

and discarding the u. Algorithmically, to obtain a single sample x of X(p):
1. Draw x←\tilde{X}.
2. Draw w←Ber (ƒₚ(x)/\tilde{ƒ}(x)).
3. If w=1, return wx, else repeat from 1.

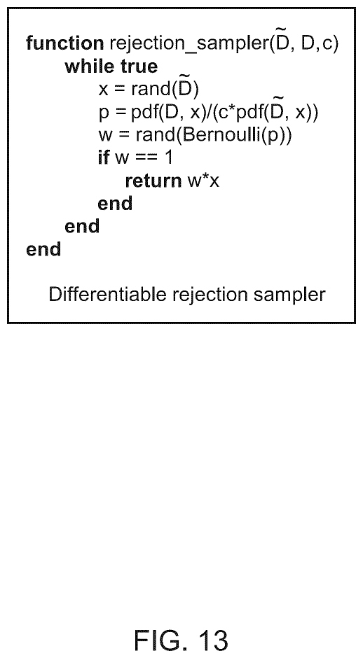

FIG. 13 depicts example source code for a differentiable rejection sampler according to an embodiment of the systems and methods described herein. The example source code shown in FIG. 13 may be integrated as part of the systems disclosed herein to implement the methods described herein.

A corresponding Julia program accepting as input the Distribution objects D and \tilde{D} of X(p) and \tilde{X} and the constant c>0: Here we multiply with the outcome of the Bernoulli variable w (which equals 1 in the primal evaluation) to make the procedure differentiable. For this, the left derivative H=−sign(h)E[X(p−|h|)−X(p)|X(p)] for the Bernoulli random variables. Then H=0 if X(p)=0 and H is still an unbiased estimator for the derivative,

$$EH / h = \frac{\partial }{\partial p} EX ( p ) ) .$$

For this, the last line inside the function can be replaced with:

return Dual{T}(a, a ? h/value(p): zero(h)/value(p))

Then, writing Y(p) for the program rejection_sampler, with

$$H = h \frac{\partial {f}_{p} ( x )}{\partial p} / {f}_{p} ( x ) = h \frac{\partial }{\partial p} log ( {f}_{p} ( x ) )$$

the primal-conditioned derivative of the last Bernoulli random variable of the loop depending on the sample x, for infinitesimal h the program Y (p+h) returns a dual

X(p)+HX(p)

which gives an unbiased estimate of the derivative of the expectation,

$$𝔼 HX ( p ) / h = 𝔼 X \frac{\partial }{\partial p} {f}_{\begin{matrix}↓ \\ p\end{matrix}} ( X ( p ) ) = \int x \frac{\partial }{\partial p} {f}_{p} ( x ) \partial x = \frac{\partial }{\partial p} 𝔼 X ( p )$$

where the last equality holds under regularity conditions. This occurs by compositionality where the function rejection_sampler is automatically differentiable in parameters of the law D of X(p), as it is written with the definition of derivative of rand(Bernoulli(p)) given earlier.

While previous values of wᵢ and xᵢ sampled in step 1 and 2 are discarded, they can be thought of as included in the sum

$$\frac{1}{n} {\sum }_{j = 1}^{n} {Y}^{j} ( p + h ) = \frac{1}{{Σ}_{i} W ( i )} {\sum }_{i} ( {W}^{( i )} {\tilde{X}}^{( i )} + {H}_{i} {W}^{( i )} {\tilde{X}}^{( i )} )$$

as true zeros (zeros with zero increment). It is appreciated that when estimating

$$\frac{\partial }{\partial p} Eg ( X ( p ) ) ,$$

it is preferable to return weight and value in rejection_sampler separately, as

$$\frac{\partial }{\partial p} 𝔼 g ( X ( p ) ) = 𝔼 [ g ( Y ( p ) ) H / h ]$$

Applications: Differentiable Particle Filter

In a particle sampler, particles are resampled with particles with high weight having proportionally higher chance to be selected. The particle sampler is advantageous because numerical effort is not wasted on particles not selected, which tend to have low weight.

A similar effect may be achieved by retaining each particle independently with probability proportional to its weight. Again, a particle with zero weight is dropped from further computations. But an infinitesimal increment to the probability argument, such as h in a random variable X(h)˜Ber(h), has an infinitesimal (not negligible) probability of turning a zero weight positive. Choosing the signed left derivative as before, a primal-conditioned derivative is obtained with the right expectation and the property that particles ending up with zero weight, also end up with zero derivative, so can be entirely neglected for calculations of expected values of the primal sampler or its derivative.

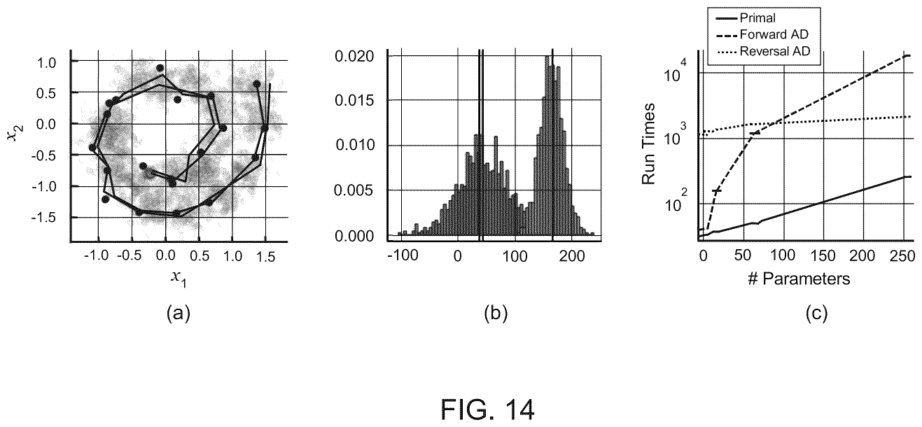

FIG. 14 illustrates an exemplary particle sampler application of the systems and methods described herein. Chart (a) shows a latent process and observations and included particles with resampling steps are shaded by weight. Chart (b) shows a derivative estimator is approximately Gaussian and does not have heavy tails. Chart (c) is a comparison of forward and reverse-mode AD.

Thus, systems and methods that implement an end-to-end differentiable particle sampler computing a marginal likelihood are described. A hidden Markov model with random states X₁, . . . , Xₙ is specified by a stochastic program X₁(θ) giving the starting value depending on unknown parameters θ and consecutive states given by pointwise differentiable stochastic programs Xᵢ(xᵢ−1, θ) depending on the previous state xᵢ−1=Xᵢ−1 (Markov property) and the parameters. It is convenient to assume probability densities p(x₁|θ) of X₁ and transition probability densities p(xᵢ|xᵢ−1, θ) all depending on the parameters θ. This latent process X₁, . . . , Xₙ is indirectly observed as the process Y₁, . . . , Yₙ with observations Yᵢ(xᵢ) depending on xᵢ=Xi which are specified to have smooth conditional probability densities p(yᵢ|xᵢ, θ) depending only on xᵢ and θ. A goal is to infer the unknown parameters θ given n observations y₁=Y₁, . . . , yₙ=Yₙ and particle samplers are powerful approaches to this problem.

The bootstrap particle samplers are now described, and highlight the importance of the resampling step. The bootstrap particle sampler with sufficiently regular observation regime is differentiable, except for the resampling step. As an example, consider the following system with a d-dimensional latent process,

Xᵢ=Φxᵢ₋₁+wᵢ with wᵢ˜Normal(0,Q)

yᵢ=xᵢ+vᵢ with vᵢ˜Normal(0,R)

where Q=0.02·1_{d×d}, R=0.01·1_{d×d}, x₁˜Normal(Normal(0, 1_{d×d}), 0.001·1_{d×d})), and Φ is a d-dimensional rotation matrix. This allows the calculation of a ground-truth gradient of the log-likelihood with respect to (based on a differentiation of the Kalman filter algorithm. For our computations, the number of observations n=20 is fixed. FIG. 14 visualizes the latent process, the observations, as well as the Kalman and the particle filter trajectories in d=2 dimensions. Using smoothed stochastic duals, the resampling step can be differentiated to compute an unbiased estimator. The estimator agrees with the ground-truth value from the Kalman filter, unlike biased estimators that neglect the contribution of the derivative from the resampling step (FIG. 14). Because of the similarity of smoothed stochastic dual numbers and standard dualnumbers, reverse-mode AD can also be used instead of forward-mode AD. This is convenient, as eventually reverse-mode AD becomes superior than forward-mode AD for functions ƒ: Rⁿ7→R^{m} with m>>n. For this stochastic program, it is observed that reverse-mode AD performs better for more than ˜ 100 parameters.

Next, consider a hidden Markov model where a Markov process (Xᵢ)i∈N with initial distribution p(x₁|θ) and transition densities p(xᵢ|xᵢ₋₁, θ) depending on an unknown parameter θ.

The latent process is indirectly observed as process (Yᵢ)_{i∈N} with observations Yᵢ depending Xᵢ or more precisely, with conditional distribution of Yᵢ given Y₁, . . . , Yᵢ₋₁ and X₁, . . . , Xᵢ having the (conditional) density p(yᵢ|xᵢ, θ) depending on xᵢ and θ.

Assume (Yᵢ)_{i=1, . . . , n} is observed and we are interested in the unknown parameter θ and perhaps the latent (Xᵢ)_{i=1, . . . , n}. Key quantity for statistics about θ is the likelihood

$${\overline{ω}}_{n} = p ( {y}_{1} , … , {y}_{n} \vert θ ) = {\prod }_{i = 1}^{n} p ( {y}_{i} \vert {y}_{1} , … , {y}_{i - 1} , θ ) = {\prod }_{i = 1}^{n} {v}_{i} \\ with {v}_{i} = p ( {y}_{i} \vert {y}_{1} , … , {y}_{i - 1} , θ ) .$$

We have

$${v}_{i} = \int p ( {y}_{i} \vert {x}_{i} , θ ) p ( {x}_{i} \vert {y}_{1} , … , {y}_{i - 1} , θ ) \partial {x}_{i} = \int p ( {y}_{i} \vert {x}_{i} ) p ( {x}_{i} \vert {x}_{i - 1} , θ ) p ( {x}_{i - 1} \vert {y}_{1} , … , {y}_{i - 1} , θ ) \partial {x}_{i} \partial {x}_{i - 1}$$

$$where \\ p ( {x}_{i} \vert {y}_{1} , … , {y}_{i} , θ )$$

is the density of the filtering distribution with recursion

ω̅ᵢp(xᵢ|y₁, . . . ,yᵢ,θ)=∫p(yᵢ|xᵢ)p(xᵢ|xᵢ₋₁,θ)ω̅ᵢ₋₁p(xᵢ₋₁|y₁, . . . , yᵢ₋₁,θ)∂xᵢ₋₁

with ω̅ᵢ=Πⱼ₌₁ⁱvⱼ

Demonstrations of Stochastic AD: Inhomogeneous Random Walk

Consider a Markovian random walk x₀, . . . , xₙ dependent on a parameter p, with transition behavior dependent on a parameter p.

$${x}_{n} = \{ \begin{matrix}{x}_{n - 1} + 1 with probability exp ( - \frac{{x}_{n - 1}}{p} ) \\ {x}_{n - 1} - 1 with probability 1 - exp ( - \frac{{x}_{n - 1}}{p} )\end{matrix} , {x}_{0} = 0$$

A program can be written that stochastically simulates this walk and applies an arbitrary non-linear function ƒ to the output xₙ. In practice, f may represent a loss or a likelihood estimate; in this toy setting, we take ƒ(x)=x₂. The asymptotic behavior of the variance of the automatically derived gradient estimator is important, so the initial value of p is chosen to be n so that the transition function varies appreciably over the range of the walk for all n.

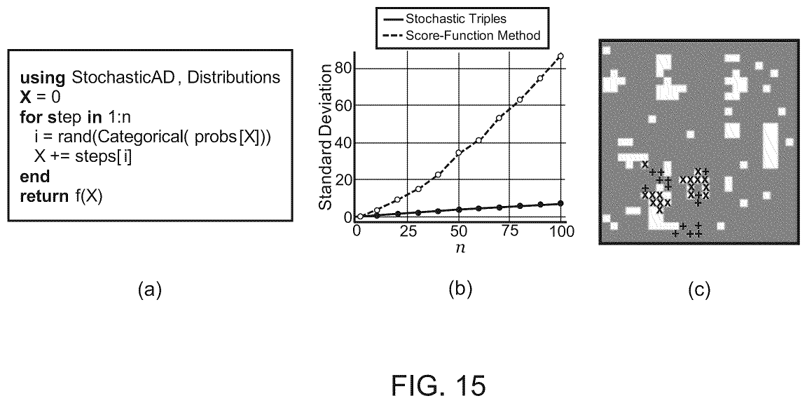

FIG. 15 illustrates automatic differentiation of discrete-time Markov processes according to an embodiment of the subject matter described herein. Box (a) of FIG. 15 depicts generic code for a 1D random walk, which may be automatically differentiated. Chart (b) of FIG. 15 illustrates the variance of unbiased gradient estimates of the random walk program using the score function and stochastic triple. Chart (c) of FIG. 15 illustrates the final board for one run of the stochastic game of life with N=12 and T=10, where the “+” signs represent additional alive cells (white) in the stochastic alternative path, and the “X” signs represent additional dead cells (grey).

FIG. 15 compares the asymptotic growth in variance of the score function estimator to that of pruned stochastic duals. Both estimators are unbiased with identical computational cost, but their variances differ by an order of magnitude. Empirically, a polynomial fit with leading term˜n^{1.5} for the variance of the score function is found, and a fit with leading order ˜n for the variance of stochastic triples is found. Crucially, stochastic triples achieve this variance reduction while operating entirely in discrete space, automatically producing a gradient estimate that is provably unbiased.

Demonstrations of Stochastic AD: Stochastic Game of Life

A program is differentiated based on a stochastic version of John Conway's Game of Life, played on a two-dimensional board. In the traditional game of life, a dead cell becomes alive when three of its neighbors are alive, while an alive cell survives when two or three of its neighbors are alive. In the stochastic version described herein, each of these events instead has probability 95%, while their complementary events have probability 5%.

Consider a program that populates each cell of an N×N board with probability p, runs the stochastic game of life for T time steps, and counts the number of alive cells nₐₗᵢᵥₑ. The object is to perform a sensitivity analysis of the final living population with respect to the initial living population, i.e., differentiate the expectation of nₐₗᵢᵥₑ with respect to p. Stochastic triples propagate fully through this program, leading to an unbiased estimate of the derivative, as verified with black-box finite differences to 0.1% tolerance. The board is depicted in FIG. 15 where the difference of the “alternative path” with infinitesimal probability considered by stochastic triples in a single run of the program is highlighted. This is a high-dimensional example (state space has dimension N²=144) with fundamentally discrete structure, providing empirical support for the algorithmic correctness of stochastic triples.

According to one embodiment, a programmatic method for performing language-level automatic differentiation of a stochastic program is disclosed. The programmatic method includes receiving a user-provided stochastic program. The programmatic method further includes generating a stochastic derivative based on the user-provided stochastic program. The programmatic method further includes generating an estimator for the user-provided stochastic program using the stochastic derivative. The estimator is unbiased. The estimator is automated. The estimator determines an estimate of a derivative of the user-provided stochastic program. The estimate of the derivative determined by the estimator may be applied to a simulation or other model to accelerate hardware running the simulation or other model.

According to another embodiment, a system for automated computation of a derivative of the expectation of a stochastic program is disclosed. The system includes a memory and at least one processor. The at least one processor is configured for automated computation of the derivative of the expectation of a stochastic program with respect to its parameters including automatically determining a derivative of an expectation of a user-provided stochastic program with respect to its input parameters, where the user-provided stochastic program includes continuous and discrete sources of randomness.

According to another embodiment, a method for automated computation of a derivative of the expectation of a stochastic program is disclosed. The method includes automatically determining a derivative of an expectation of a user-provided stochastic program with respect to input parameters of the user-provided stochastic program, wherein the user-provided stochastic program includes continuous and discrete sources of randomness.

In various embodiments of the systems and methods described herein, the estimate is applied to a simulation of the stochastic program.

In various embodiments of the systems and methods described herein, at least a portion of the programmatic method is implemented on as part of a compiler, on a general processor, on a graphics processing unit (GPU), on hardware acceleration circuitry, on a vector processing unit, or on hardware specific circuitry. The hardware specific circuitry includes at least one of an application specific integrated circuit (ASIC) and a field programmable gate array (FPGA) floating point gate array.

In various embodiments of the systems and methods described herein, the programmatic method is an application having a plurality of tasks and at least a portion of the plurality of tasks is provided to hardware specific circuitry for hardware acceleration.

In various embodiments of the systems and methods described herein, the user-provided stochastic program is received over a network.

In one embodiment, the systems and methods described herein may be used in reinforcement learning over stochastic environments. They may be used to allow for unbiased low-variance derivative estimates of the environment, allowing for the acceleration of reinforcement learning using derivative-enhanced optimization methods.

In another embodiment, the systems and methods described herein may be used for differentiation of agent-based models, such as Conway's Game of Life. They may be used to allow for the techniques of automatic differentiation to extend to this domain, allowing agent-based models of phenomena like epidemics, wild fires, chemical processes, and more to be efficiently differentiated for using in derivative-enhanced optimization routines. This can be used to allow for extending scientific machine learning (SciML) techniques, such as universal differential equations, to the case where the model is a discrete stochastic model like an agent-based model. For example, this allows the universal differential equation training technique to train neural network rate functions within agent-based models and automatically discover missing functions via subsequent symbolic regression within this context.

In another embodiment, the systems and methods described herein may be used to provide direct differentiation of continuous-time Markov chains with Poisson or alternative rate distributions simulated by Gillespie-type algorithms and derivatives in an unbiased and low-variance way. Gillespie processes can be used in the context of systems biology, systems pharmacology, clinical pharmacology, synthetic biology, and in chemical manufacturing for the simulation of the (bio)chemical processes with respect to stochasticity. This differentiation process allows for fast derivatives for derivative-based optimization, faster model calibration, and the extension of universal differential equation techniques (and model discovery) to this domain.

In another embodiment, the systems and methods described herein may use a differentiable particle filter in all contexts in which a traditional particle filter would be used, but fast and accurate derivative information may be used to accelerate the fit, such as in clinical pharmacology nonlinear mixed effects modeling where particle filters can be used for Bayesian estimation.

In another embodiment, the systems and methods described herein may be applied to rule-based models. Rule-based models are commonly used for generating accurate simulations of physical and biological phenomena. For example, rule-based models have been used to create digital twins of cells, organs, and more. This allows for generating quick and accurate derivatives for calibrating these models against data and extending them to the SciML techniques such as universal differential equations. Thus, the systems and methods described herein may be used in cases like pharmacology. Similarly, the systems and methods described herein may be applied to stochastic Boolean networks to generate quick and accurate derivatives to be used in cases such as biology, gene regulatory networks, and the like.

Aspects of the present disclosure may take the form of an entirely hardware embodiment, an entirely software embodiment as a programmatic method (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including the Julia scientific computing language or an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These non-transitory computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The systems and methods described herein may use a component architecture made up of composable subsystem components. The composable subsystem components may be reusable trained surrogates. As used herein, component-based modeling refers to stitching together a large-scale causal or acausal model using trained surrogates. The composable subsystem components are reusable, such that the subsystem components (i.e., surrogates) have been trained, and a library of the trained surrogates is created, which allows for large-scale models to be built using the trained surrogates, and the trained surrogates provide for automatic acceleration of the model. In this way, complex models are built by stitching together pre-designed, pre-shrunk components consisting of self-contained systems. Thus, using trained surrogates for modeling purposes and accelerated differential-equation solving creates an architecture that can solve and/or simulate complex physical processes that were previously infeasible to solve in a commercially reasonable time.

The systems and methods described herein may provide a library of trained surrogates that can be used and reused by users without specialized experience in scientific computing. In some embodiments, the systems and methods described herein may use GPU computing or distributed parallelism with the surrogates to compute the results even faster.

In some embodiments, neural or universal differential equations are used as surrogates for the components. These models are differential equations that have a learnable nonlinear function, such as a Gaussian process, radial basis function, polynomial basis functions (Chebyshev polynomials, Legendre polynomials, etc.), Fourier expansions, or a neural network. These function representations can be trained to predict accurate timeseries for the dynamics of a given component. In some embodiments, the system of differential equations that is learned is smaller than the original component, making it known as a nonlinear model order reduction.

In some embodiments, surrogates, such as continuous or discrete time echo state networks, may be used to emulate the behavior of a component. Echo state networks are processes which simulate a dynamical reservoir process and learn a projection matrix to recover the dynamics. While this case may not result in a smaller system, this representation can be much more efficient to compute due to having numerical properties such as decreased stiffness.

In some embodiments, the direct computation of the timeseries outputs may be approximated by a surrogate such as a (physics-informed) neural network or radial basis function, providing a mesh-free representation of the time series which can be sampled as necessary within the composed simulation.

The subject matter described herein may include the use of machine learning performed by at least one processor of a computing device and stored as non-transitory computer executable instructions (software or source code) embodied on a non-transitory computer-readable medium (memory). Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The systems and methods may support different hardware platforms/architectures, may add implementations for new network layers and new hardware platforms/architectures, and may be optimized in terms of processing, memory and/or other hardware resources for a specific hardware platform/architecture being targeted. Examples of platforms are different GPUs (e.g., Nvidia GPUs, ARM Mali GPUs, AMD GPUs, etc.), different forms of CPUs (e.g., Intel Xeon, ARM, TI, etc.), and programmable logic devices, such as Field Programmable Gate Arrays (FPGAs).

Exemplary target platforms include host computers having one or more single core and/or multicore CPUs and one or more Parallel Processing Units (PPUs), such as Graphics Processing Units (GPUs), and embedded systems including single and/or multicore CPUs, microprocessors, Digital Signal Processors (DSPs), and/or Field Programmable Gate Arrays (FPGAs).

The subject matter described herein may be executed using a distributed computing environment. The environment may include client and server devices, interconnected by one or more networks. The distributed computing environment also may include target platforms. The target platform may include a multicore processor. Target platforms may include a host (Central Processing Unit) and a device (Graphics Processing Unit). The servers may include applications or processes accessible by the clients. The devices of the environment may interconnect via wired connections, wireless connections, or a combination of wired and wireless connections.

The servers may include one or more devices capable of receiving, generating, storing, processing, executing, and/or providing information. For example, servers may include a computing device, such as a server, a desktop computer, a laptop computer, a tablet computer, a handheld computer, or a similar device.

The clients may be capable of receiving, generating, storing, processing, executing, and/or providing information. Information may include any type of machine-readable information having substantially any format that may be adapted for use, e.g., in one or more networks and/or with one or more devices. The information may include digital information and/or analog information. The information may further be packetized and/or non-packetized. In an embodiment, the clients may download data and/or code from the servers via the network. In some implementations, the clients may be desktop computers, workstations, laptop computers, tablet computers, handheld computers, mobile phones (e.g., smart phones, radiotelephones, etc.), electronic readers, or similar devices. In some implementations, the clients may receive information from and/or transmit information to the servers.

The subject matter described herein and/or one or more of its parts or components may comprise registers and combinational logic configured and arranged to produce sequential logic circuits. In some embodiments, the subject matter described herein may be implemented through one or more software modules or libraries containing program instructions pertaining to the methods described herein, that may be stored in memory and/or on computer readable media, and may be executed by one or more processors. Other computer readable media may also be used to store and execute these program instructions. In alternative embodiments, various combinations of software and hardware, including firmware, may be utilized to implement the present disclosure.

A person having ordinary skill in the art will recognize that the principles described herein may be applied to other physical systems not explicitly described herein, as the model described herein here provides a framework that is not specific to any particular physical system but rather can be used to build surrogates that represent components of any physical system.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A programmatic method for performing language-level automatic differentiation of a stochastic program, the programmatic method comprising:
receiving a user-provided stochastic program;
generating a stochastic derivative based on the user-provided stochastic program; and
generating an estimator for the user-provided stochastic program using the stochastic derivative,
wherein the estimator determines an estimate of a derivative of the user-provided stochastic program.

2. The programmatic method of claim 1, further comprising outputting the estimate of the derivative of the user-provided stochastic program.

3. The programmatic method of claim 1, wherein computation of a primal and computation of a derivative are coupled to reduce variance in the estimate of the derivative.

4. The programmatic method of claim 1, wherein the estimate of the derivative is a primal-conditioned derivative.

5. The programmatic method of claim 1, wherein the stochastic derivative is composable.

6. The programmatic method of claim 1, wherein the programmatic method preserves structure of the user-provided stochastic program.

7. The programmatic method of claim 1, wherein the estimator includes a differentiable particle filter.

8. The programmatic method of claim 1, wherein the estimator performs forward-mode automatic differentiation or reverse-mode automatic differentiation.

9. A computer system for computation of derivatives of stochastic programs, the computer system comprising:
a memory and at least one processor, the at least one processor configured for:
automatically determining a derivative of an expectation of a user-provided stochastic program based on input parameters of the user-provided stochastic program, wherein the user-provided stochastic program includes continuous and discrete sources of randomness.

10. The computer system of claim 9, wherein the at least one processor is further configured for using a differentiable particle filter to accelerate the determination of the derivative of the expectation of the user-provided stochastic program.

11. The computer system of claim 9, wherein the at least one processor is further configured for generating a composable data structure configured to propagate through the discrete and continuous sources of randomness without accruing bias, wherein the composable data structure is a stochastic dual or a stochastic triple.

12. The computer system of claim 9, wherein the at least one processor is further configured for automatically augmenting an arbitrary stochastic program to return a stochastic derivative whose samples estimate the derivative of the stochastic program's expectation with respect to the input.

13. The computer system of claim 9, wherein the at least one processor is further configured for performing forward and backward automatic differentiation to automatically differentiate the user-provided stochastic program in expectation based on the input parameters.

14. The computer system of claim 9, wherein the at least one processor is further configured for determining conditional expectations of pathwise derivatives.

15. A programmatic method for computation of derivatives of stochastic programs, the programmatic method comprising:
automatically determining a derivative of an expectation of a user-provided stochastic program with respect to input parameters of the user-provided stochastic program, wherein the user-provided stochastic program includes continuous and discrete sources of randomness.

16. The programmatic method of claim 15, further comprising using a differentiable particle filter to accelerate determination of the derivative of the expectation of the user-provided stochastic program.

17. The programmatic method of claim 15, further comprising generating a composable data structure configured to propagate through the discrete and continuous sources of randomness without accruing bias, wherein the composable data structure is a stochastic duel or a stochastic triple.

18. The programmatic method of claim 15, further comprising automatically augmenting an arbitrary stochastic program to return a stochastic derivative whose samples estimate the derivative of the program's expectation with respect to the input.

19. The programmatic method of claim 15, further comprising performing forward and backward automatic differentiation to automatically differentiate the user-provided stochastic program in expectation with respect to the input parameters.

20. The programmatic method of claim 15, further comprising determining conditional expectations of pathwise derivatives.
